(19) United States
(12) Patent Application Publication
(10) Pub. No.: US 2017/0265598 A1
(43) Pub. Date: Sep. 21, 2017

(54) METHOD OF MAKING MULTI-COLORED OBJECTS

(71) Applicant: NIKE, Inc., Beaverton, OR (US)

(72) Inventors: Tiffany A. Beers, Portland, OR (US); Andrew A. Owings, Portland, OR (US); Anna Schoborg, Beaverton, OR (US)

(21) Appl. No.: 15/459,521

(22) Filed: Mar. 15, 2017

Related U.S. Application Data
(60) Provisional application No. 62/308,539, filed on Mar. 15, 2016.

(51) Int. Cl. A43D 95/06; B05D 3/00; A43B 1/00; B05D 1/18

(52) U.S. Cl. CPC A43D 95/06; B05D 1/18; B05D 3/007; A43B 1/0027

(57) ABSTRACT

A method is described for coloring an article including a light diffuser. The article is dipped into a liquid colorant to a first predetermined depth for first short period less than the 100 percent single dip saturation time. The article then is removed from the liquid colorant and dried. The article may be dipped into a liquid colorant to a second predetermined depth for a second short period, then removed and dried. The dyeing and drying steps are repeated until the article is imbued with the selected color and saturation.

### CROSS-REFERENCE TO RELATED APPLICATIONS

This application claims the benefit of priority from U.S. Provisional Appl. Ser. No. 62/308,539, filed Mar. 15, 2016, the entirety of which is incorporated by reference as if fully set forth herein.

### BACKGROUND

The present invention relates generally to a method for dyeing articles. In particular, the application relates to a method for dyeing articles to achieve a solid color, a gradient of color, or multiple colors quickly and efficiently.

Color change often is used to imbue articles that comprise multiple pieces of differing compositions with selected color or colors. For example, an article of footwear may have two primary elements: an upper and a sole system. The upper is often formed from a plurality of material elements (e.g., textiles, polymer sheet layers, foam layers, leather, and synthetic leather) that are stitched or adhesively bonded together to form a void on the interior of the footwear for comfortably and securely receiving a foot. More particularly, the upper forms a structure that extends over instep and toe areas of the foot, along medial and lateral sides of the foot, and around a heel area of the foot. The upper may also incorporate a lacing system to adjust the fit of the footwear, as well as permitting entry and removal of the foot from the void within the upper.

Sole systems for footwear can include one or more components or components. These can include outsoles, midsoles, insoles, inserts, bladders and/or airbags as well as possibly other articles or components.

Whereas some of these parts may be inherently colored, other parts may be clear, white, or another color that may be changed in accordance with user preferences.

Dyeing of articles long has been practiced, whether to satisfy need to have articles available in different colors, to match one article to another or to provide contrast between articles, or to decorate an article in a preferred manner. Dyeing often is an effective way to impart a selected color to an article.

Dyeing may be carried out by contacting an article with a substance such as a dye that will change the color of the article. Sometimes the composition of the dye may be selected based on the material composition from which the article is made. Dye may impart color change that is essentially permanent, or may be temporary and removable, for example, by washing or treating with a solvent.

Contact between dye and an article to be colored may be achieved by spraying or pouring dye on the article, for example, or by immersing the article into a composition of die in a container. Coloring articles with liquid dye can be a lengthy process, with a significant period required both to achieve a preselected color and to dry the colored article. The period lengthens when, for example, more than one color is to be applied.

Therefore, there exists a need in the art for a method for coloring articles quickly and efficiently to obtain a solid color, a gradient of at least one color, a color match, or to combine 2 or more colors on the same article. In particular, the need for such a system exists in the manufacture of articles of footwear.

### SUMMARY

While in general acid dyes, also known as anionic dyes, do not dye polyurethane materials well under mild dyeing conditions, only lightly tinting the polyurethane materials, it has been discovered that addition of various ammonium salts to a dye solution increases affinity of the acid dye molecules toward the polyurethane materials to provide intensely colored products with good colorfastness.

In addition, dip time for coloring under known methods may exceed 60 minutes, to achieve 100 percent saturation. However, in accordance with embodiments of the disclosure, articles that are repeatedly dipped into a colorant, removed from the colorant, and dried, may achieve a selected color saturation in significantly less time than a single dip/dry cycle.

In one aspect, therefore, this disclosure provides a method for coloring an article including a light diffuser, wherein the light diffuser is made of a polyurethane material (e.g., a thermoplastic polyurethane, such as a transparent thermoplastic polyurethane). In some embodiments, the article is an article of footwear. In various embodiments, the article of footwear includes a sole structure. In some embodiments, the light diffuser is embedded or otherwise mounted on or in a sole structure of an article of footwear. In some embodiments, the light diffuser can be the same color or a different color relative to the sole structure.

The article is dipped into a dye bath to a first predetermined depth for a first short period less than a dipping time period required to achieve complete saturation. The article then is removed from the dye bath and dried. The article may be dipped again into the dye bath to a second predetermined depth for a second short period, then removed and dried. The dyeing and drying steps are repeated until the article is imbued with the selected color and saturation.

In another aspect, the disclosure provides a method wherein the article is dipped into different color dye baths and dried to achieve a combination of colors.

In another aspect of the disclosure, the article is dipped into a dye bath to different depths and dried to achieve a range of color saturation, such as a gradient of color, on the article.

In still another aspect, the disclosure provides a method wherein the article is dipped repeatedly into a dye bath to imbue the article with the selected color and saturation.

The disclosure is directed to a method for coloring an article. The method may include dipping at least a first portion of the article into a first liquid colorant having a first color to a first predetermined depth for a first short period less than the 100 percent single dip saturation time of the color. Then, the article may be removed from the liquid colorant and dried.

Alternatively or in addition, the method may include dipping at least a second portion of the dried article into a second liquid colorant having a second color to a second predetermined depth for a second short period less than the 100 percent single dip saturation time of the second color. The article then is removed from the liquid colorant and dried. The article may be dipped into water or another rinse agent between dips.

The dyeing and drying steps may be repeated until the article is imbued with the selected colors and saturations. The article may be a part of an article of footwear, such as a midsole, an outsole, or an air bladder. The article may be a part of another article, such as a light diffuser that forms part of a heel counter or of a sole plate of an article of footwear. The colors on the portions may be overlapped to form a third color. The portions may be the same size or may be different sizes. In some embodiments, the portions may be different sizes.

The colorants may be metal complex dyes, acid dyes, or other dyes suitable for the substrate.

The disclosure also is directed to a method for dyeing an article to a predetermined saturation, wherein the predetermined saturation is normally achieved by placing the article in a liquid colorant for a 100 percent single dip saturation time and then drying the article for a 100 percent drying time. In accordance with the method, the article is placed in the liquid colorant for a first short period less than the 100 percent single dip saturation time. The article then is removed from the liquid colorant for a first short drying period.

The article is returned to the liquid colorant for a second short period less than the 100 percent single dip saturation time then removed from the liquid colorant for a second short drying period. The first short period plus the first short drying period plus the second short period plus the second short drying period, when added together, are cumulatively less than the 100 percent single dip saturation time and 100 percent single dip saturation drying time added together.

The method for dyeing an article to a predetermined saturation wherein the first short period plus the first short drying period plus the second short period plus the second short drying period, when added together, are cumulatively less than the 100 percent single dip saturation time and 100 percent single dip saturation drying time added together, can be a method wherein the temperature of the liquid colorant is higher than a liquid colorant temperature which would deform the article when conducted for the 100 percent single dip saturation time. The liquid colorant temperature can be above about 35° C. The liquid colorant temperature can be from about 35° C. to 50° C., or from 35° C. to 40° C., or from 40° C. to 50° C.

The method for dyeing an article to a predetermined saturation wherein the first short period plus the first short drying period plus the second short period plus the second short drying period, when added together, are cumulatively less than the 100 percent single dip saturation time and 100 percent single dip saturation drying time added together can be a method wherein the liquid colorant comprises an acid dye. The liquid colorant comprising an acid dye can include an anionic dye compound, a quaternary ammonium salt selected from soluble tetrabutylammonium compounds and tetrahexylammonium compounds, and, optionally, a water-soluble organic solvent. The acid dye can be present in an amount of from about 0.001 g/L to about 5.0 g/L, or from about 0.01 g/L to about 2 g/L.

The method for dyeing an article to a predetermined saturation wherein the first short period plus the first short drying period plus the second short period plus the second short drying period, when added together, are cumulatively less than the 100 percent single dip saturation time and 100 percent single dip saturation drying time added together can be a method wherein the liquid colorant comprises an acid dye and the temperature of the liquid colorant is higher than a liquid colorant temperature which would deform the article when conducted for the 100 percent single dip saturation time.

The first short period and the second short period may be independently between about 5 seconds and about 120 seconds, or independently between about 10 seconds and about 60 seconds, or independently less than about 5 percent of the 100 percent single dip saturation time.

The article may be dipped into the liquid colorant less than about 40 times with short periods less than about 2 percent of the 100 percent single dip saturation time. Alternatively, the article may be dipped into the liquid colorant less than about 25 times with short periods less than about 3 percent of the 100 percent single dip saturation time. In yet another alternative, the article may be dipped into the liquid colorant less than about 10 times with short periods less than about 5 percent of the 100 percent single dip saturation time.

The disclosure also is directed to a method for dyeing an article to have a first area having a first predetermined saturation of a first color and a second area having a second predetermined saturation of a second color, wherein the first predetermined saturation normally is achieved by placing the article in a first liquid colorant for a 100 percent single dip saturation time and then drying the article for a first 100 percent single dip saturation drying time, and the second predetermined saturation normally is achieved by placing the article in a second liquid colorant for a second 100 percent single dip saturation time and drying the article for a second 100 percent single dip saturation drying time

The method includes placing the article in the first liquid colorant for a first short period than the 100 percent single dip saturation time. The article then is removed from the first liquid colorant for a first drying time period, and then placed back into the first liquid colorant for a second short period less than the first 100 percent single dip saturation time. The article is removed the first liquid colorant for a second short drying period.

The article then may be placed in the second liquid colorant for a third short period less than the second 100 percent single dip saturation time, and then removed from the second liquid colorant for a third short drying period. The article then is placed back into the second liquid colorant for a fourth short period less than the second 100 percent single dip saturation time, and then removed from the second liquid colorant for a fourth short drying period.

The first short period plus the first short drying period plus the second short period plus the second short drying period, when added together, are cumulatively less than the first 100 percent single dip saturation time and first 100 percent single dip saturation drying time. Also, the third short period plus the third short drying period plus the fourth short period plus the fourth short drying period, when added together, are cumulatively less than the second 100 percent single dip saturation time and second 100 percent single dip saturation drying time.

The method may further comprise dipping the article into a wash bath before again dipping the article into another liquid colorant.

In the method, the first short period, the second short period, the third short period, and the fourth short period may be independently between about 5 seconds and about 120 seconds. In other embodiments, the first short period, the second short period, the third short period, and the fourth short period are independently between about 10 seconds and about 60 seconds. The first short period and the second short period may be independently less than about 3 percent of the first 100 percent single dip saturation time, and the third short period and the fourth short period may be independently less than about 3 percent of the second 100 percent single dip saturation time.

The disclosure also is directed to a part of an article of footwear having a colored portion. The colored portion may be formed by dipping at least a first portion of the article into a first liquid colorant having a first color to a first predetermined depth for a first short period less than the 100 percent single dip saturation time of the color, then removing the article from the liquid colorant and drying the article.

The disclosure can include any combination of the various features set forth in this application. Any combination of disclosed features herein is considered part of the disclosure, and no limitation is intended with respect to combinable features.

Other systems, methods, features, and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic isometric view of an embodiment of a multi-colored article;

FIG. 2 is a different schematic isometric view of an embodiment of a multi-colored article;

FIG. 3 is a schematic isometric cutaway view of an embodiment of an apparatus used to produce a multicolored article;

FIG. 4 is different schematic isometric cutaway view of an embodiment of an apparatus used to produce a multicolored article;

FIG. 5 is a schematic view of an embodiment of an apparatus shown in FIGS. 3 and 4, in a different position;

FIG. 6 is a schematic view of an embodiment of an apparatus shown in FIG. 5, in a different position;

FIG. 7 is a schematic view of an embodiment of an apparatus shown in a different position, with an inverted article;

FIG. 8 is a schematic view of an embodiment of an apparatus shown in yet a different position, with an inverted article;

FIG. 9 is a schematic view of an embodiment of an apparatus shown in yet a different position, with an inverted article;

FIG. 10 is a schematic view of an embodiment of an apparatus holding an article in a different position;

FIG. 11 is a schematic view of an embodiment of a multi-colored article resulting from an apparatus embodied in FIG. 10;

FIG. 12 is a schematic view of an embodiment of an apparatus holding an article in yet a different position;

FIG. 13 is a schematic view of an embodiment of a multi-colored article resulting from an apparatus embodied in FIG. 12;

FIG. 14 is a schematic plan view of an embodiment of an article having a color gradient;

FIG. 15 is a schematic plan view of a different embodiment of an article having a color gradient;

FIG. 16 is a schematic plan view of another embodiment of an article having a color gradient;

FIG. 17 is a schematic view of an embodiment of an apparatus used to produce a multi-colored article;

FIG. 18 is a schematic view of an embodiment of an apparatus used to produce a multi-colored article;

FIG. 19 is a schematic view of an embodiment of an apparatus of FIG. 18 used to produce a multi-colored article, in a different position;

FIG. 20 is a schematic view of an embodiment of an apparatus of FIG. 18 used to produce a multi-colored article, in another position; and

FIG. 21 is a schematic view of an embodiment of an apparatus of FIG. 18 used to produce a multi-colored article, in still another position.

FIGS. 22-23 are photographs of a heel counter including a diffuser.

FIGS. 24-26 are diagrams showing a sole plate including a diffuser.

FIGS. 27-30 are diagrams illustrating a relationship between a sole plate including a diffuser and a sole assembly.

FIG. 31 is a diagram showing a diffuser in a sole plate in an unlit and a lit condition.

FIGS. 32-34 are diagrams illustrating dyeing a sole plate in a vertical position orientation.

FIG. 35 is a diagram illustrating dyeing a sole plate in a horizontal position or orientation.

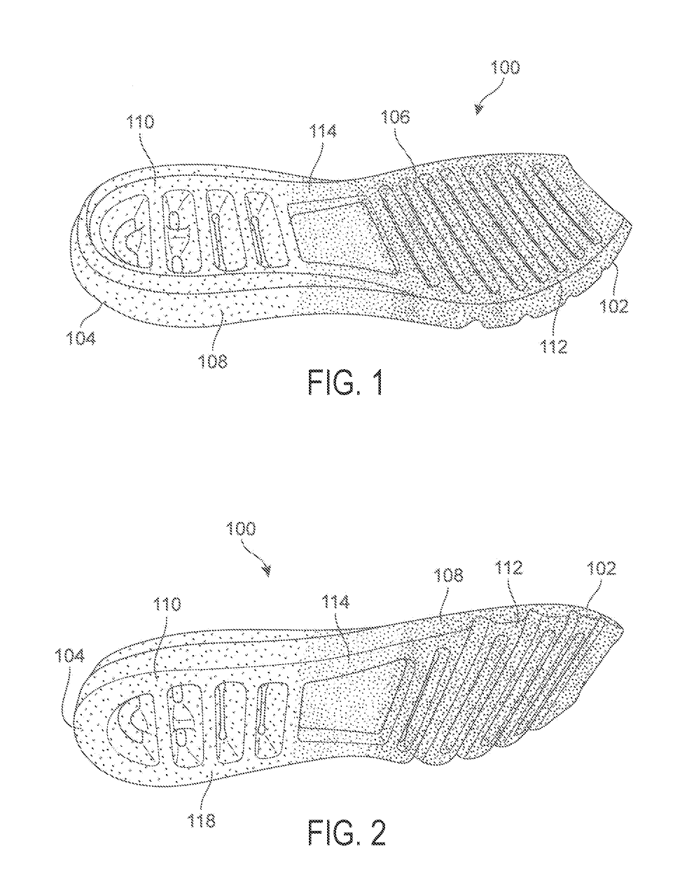

FIGS. 1-21 illustrate a method that may be used in accordance with embodiments of the disclosure. The method is illustrated and described in detail with regard to dyeing a midsole or a bladder for an article of footwear.

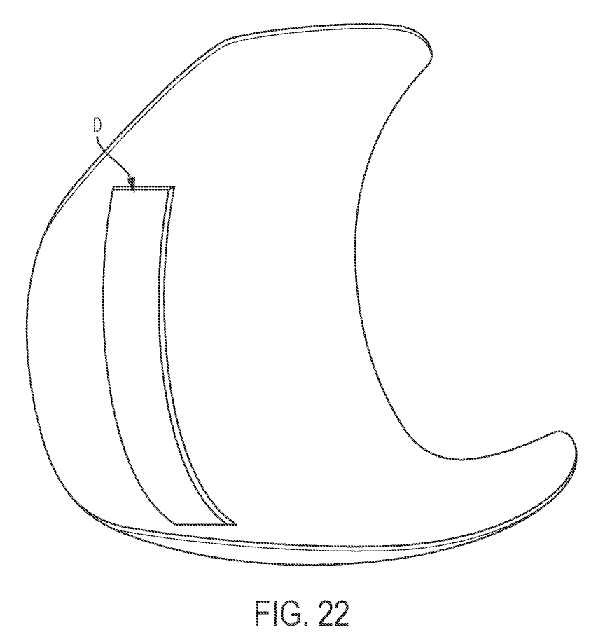

FIGS. 22-31 illustrate embodiments of a light diffuser for an article of footwear. In one embodiment, the diffuser forms a part of a sole plate. In another embodiment, the diffuser forms part of a heel counter. In embodiments of the disclosure, the light diffuser may be treated in accordance with embodiments similar to a method for acid dyeing a midsole or a bladder for an article of footwear, as illustrated in FIGS. 1-21.

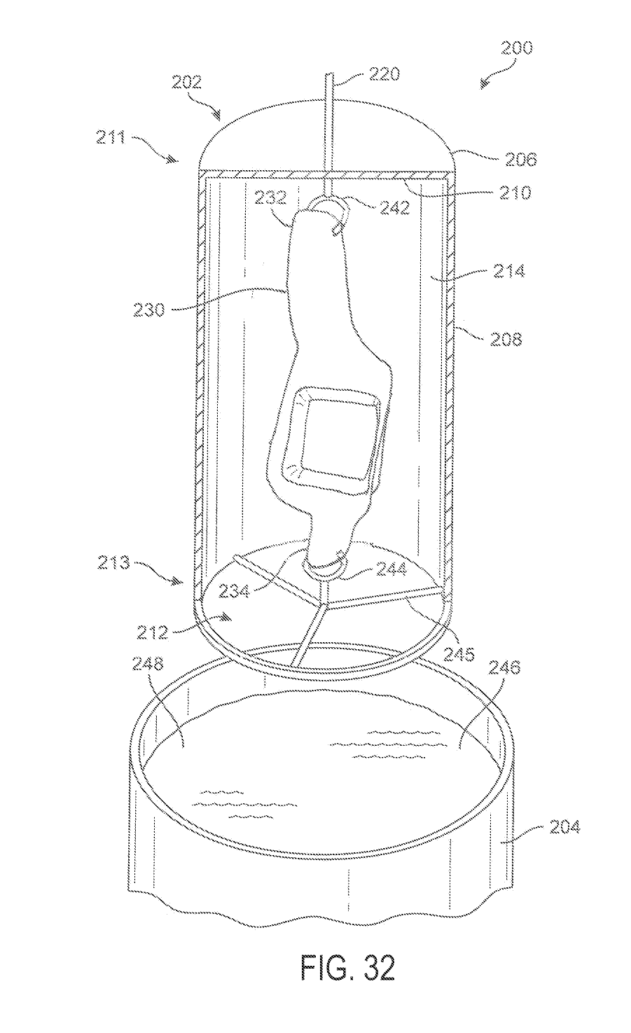

FIGS. 32-35 illustrate embodiments of acid dying of a light diffuser for an article of footwear in accordance with a dyeing embodiment involving dipping.

### DETAILED DESCRIPTION

In one aspect, this disclosure provides a method for coloring an article. The article may be dipped into a dye bath to a first predetermined depth for a first short period less than the dipping time period required to achieve complete saturation. The article then is removed from the dye bath and dried for a drying period. The article may be dipped again into a dye bath to a second predetermined depth for a second short period, then removed and dried for a second drying period. The dyeing and drying steps may be repeated until the article is imbued with the selected color and saturation.

Embodiments of the disclosure provide a method wherein the article may be dipped into different color dye baths and dried to achieve a combination of colors.

In embodiments of the disclosure, the article may be dipped into a dye bath to different depths and dried to achieve a range of color saturation, such as a gradient of color, on the article.

In embodiments of the disclosure, the article may be dipped repeatedly into a dye bath or baths in a series of dip/dry cycles to imbue the article with a selected color and saturation.

The cycle of one dip into a dye bath and removal for a drying period also may be known as a dip/dry cycle. In accordance with embodiments of this disclosure, the length of the period during which an article remains in the dye bath is short, for example, less than about two minutes, less than about one minute, and less than about 50 seconds. In other embodiments, the dip period is less than about 30 seconds, for example, between about 1 second and about 20 seconds, and between about 3 seconds and about 10 seconds. In accordance with embodiments of the disclosure, a drying period associated with a dip sometimes has a length less than or equal to the length of the dip period.

As used herein, “color” means hue, such as red, green, blue, or any other hue. “Saturation” means intensity of the hue. Low saturation yields a light color, and high saturation provides a vivid color. Thus, an article may have a portion having a color, such as red. A constant red color is perceived if the saturation is essentially constant. However, if saturation is different in different parts of the colored portion, the red color may appear to be pale where saturation is lower. Thus, a gradient of color on an article is provided by a range of saturation of a color.

As used herein, a “short” period is a period less than about 10 percent, for example, less than about 5 percent, less than about 3 percent, less than about 2 percent, and less than about 1 percent, as long as the period required to achieve 100 percent saturation in a single dip. Drying times are similarly shortened and are identified as short drying periods. For the purposes of this disclosure, the selected saturation level will be referred to as “100 percent saturation,” even though higher saturation levels may be available. Similarly, the time required to achieve the selected saturation, i.e., 100 percent saturation, in a single dip will be referred to herein as the “100 percent single dip saturation time” and the subsequent drying period will be referred to herein as the “100 percent saturation single dip time drying time.”

In embodiments of the disclosure, a selected saturation level may be achieved with fewer dips and therefore less time than would be expected by simply taking a ratio with the percentage dip time. For example, if the short period for the dip is 2 percent of the 100 percent single dip saturation time for achieving 100 percent saturation, one might expect that 50 dip/dry cycles would be required to achieve 100 percent saturation. However, in embodiments of the disclosure, 100 percent saturation may be achieved in 45 dip/dry cycles, or 90 percent of the 100 percent time. In some embodiments of the disclosure, 100 percent saturation may be achieved in less than about 40 dip/dry cycles, less than about 35 dip/dry cycles, less than about 30 dip/dry cycles, less than about 25 dip/dry cycles, less than about 20 dip/dry cycles, and less than about 10 dip/dry cycles.

The short cycle times of the disclosure are made possible by the temperature of the dye bath and the increased dye penetration achieved at the chosen temperatures. For example, the temperature of a dye bath for a temperature-sensitive object, such as an inflated bladder, may be below about 35° C. or about 30° C. Higher temperatures may mar sensitive objects, or may cause an inflated bladder to deform or burst within the period required to obtain the selected color. However, limiting the period of exposure to the dye to a short period affords the opportunity to raise the temperature of the dye bath without deforming a temperature-sensitive object. Further, evaporation of volatile components of the dye solution may cool the object during drying periods. Also, the higher dye temperature yields greater and faster penetration of the dye into many substrates.

Any article may be colored in accordance with the method of the disclosure. As the user recognizes, the dye should be compatible with the composition of matter of the article. For example, if the article is wood, the dye may be a wood stain. Similarly, if the article is metal, a suitable coating for metal may be selected. Cloth and fabrics also may be colored, as may polymeric materials. The dye for polymeric material is selected for compatibility with the substrate. Uneven drying, such as streaking and spotting, may result if the dye is not compatible with the substrate, or if immiscible additives, such as oil in an aqueous composition, are present. The user purposefully may seek such inconsistencies as a form of decoration. Also, dyeing may not be permanent if the dye is not compatible with the substrate. With the guidance provided herein, the user will be able to identify and select suitable dye or colorant compositions.

The article to be colored in accordance with the disclosure may comprise two or more compositions of matter. In such a circumstance, the colorant may selected to be compatible with both compositions. As the user recognizes, colorant used in an embodiment of a method of this disclosure may be one that imparts a saturation that increases as contact between the article and the colorant is increased. Thus, a typical colorant may be a dye or a stain, i.e., a translucent or transparent composition that bonds with or penetrates a substrate, rather than a paint or similar coating that is converted to an opaque solid film on the surface of the substrate. The user recognizes that metal coatings may be film-forming. For the purposes of this disclosure, metal coatings should be of the type that, although they may form films, provides a transparent or translucent color. With the guidance provided herein, the user will be able to select the dye or colorant suitable for an article to be colored.

Articles that may be colored in accordance with the disclosure include articles that can be dipped into a liquid colorant or liquid coloring agent. The terms “liquid colorant” and “liquid coloring agent,” as used throughout this detailed description and in the claims, refer to any liquid that includes or incorporates one or more coloring agents. Liquid coloring agents can include, but are not limited to: liquids with any kinds of coloring agents, including liquids with dyes, liquids with pigments, and any other liquid based coloring agents that are known in the art.

The embodiments of the articles described herein may incorporate dyeing methods as well as particular dye compositions. Some embodiments may use one or more of the features, methods, systems and/or components disclosed in the following documents: Tutmark, United States Patent Application Publication 2014/0256468, published Sep. 11, 2014, titled “Method for Dyeing Golf Balls and Dyed Golf Balls”; Schoborg, United States Patent Application Publication 2014/0250611, published Sep. 11, 2014, titled “Acid Dyeing of Polyurethane Materials”; Tutmark, United States Patent Application Publication 2014/0250609, published Sep. 11, 2014, titled “Method for Dyeing Golf Balls and Dyed Golf Balls”; Bracken et al., U.S. Pat. No. 7,611,547, issued Nov. 3, 2009, titled “Airbag Dyeing Compositions and Processes,” the entireties of each of which published patent applications and issued US patent are incorporated by reference as if fully set forth herein.

In particular, acid dyes may be used in embodiments. Acid dye solutions are stable and less expensive relative to metal complex dye solutions for dyeing polyurethane. The process of dyeing polyurethane articles with acid dye solution produces strong color intensity. A wide selection of colors is available, including bright colors unavailable using metal complex dyes.

A polyurethane material may be dyed in an acid dye solution including an anionic dye compound, a quaternary ammonium salt selected from soluble tetrabutylammonium compounds and tetrahexylammonium compounds, and, optionally, a water-soluble organic solvent.

Acid dyes are water-soluble anionic dyes. Acid dyes are available in a wide variety, from dull tones to brilliant shades. Chemically, acid dyes include azo, anthraquinone and triarylmethane compounds.

The “Color Index” (C.I.), published jointly by the Society of Dyers and Colourists (UK) and by the American Association of Textile Chemists and Colorists (USA), is the most extensive compendium of dyes and pigments for large scale coloration purposes, including 12000 products under 2000 C.I. generic names. In the C.I., each compound is presented with two numbers referring to the coloristic and chemical classification. The “generic name” refers to the field of application and/or method of coloration, while the other number is the “constitution number.” Non-limiting examples of acid dyes include Acid Yellow 1, 17, 23, 25, 34, 42, 44, 49, 61, 79, 99, 110, 116, 127, 151, 158:1, 159, 166, 169, 194, 199, 204, 220, 232, 241, 246, and 250; Acid Red 1, 14, 17, 18, 42, 57, 88, 97, 118, 119, 151, 183, 184, 186, 194, 195, 199, 211, 225, 226, 249, 251, 257, 260, 266, 278, 283, 315, 336, 337, 357, 359, 361, 362, 374, 405, 407, 414, 418, 419, and 447; Acid Violet 3, 5, 7, 17, 54, 90, and 92; Acid Brown 4, 14, 15, 45, 50, 58, 75, 97, 98, 147, 160:1, 161, 165, 191, 235, 239, 248, 282, 283, 289, 298, 322, 343, 349, 354, 355, 357, 365, 384, 392, 402, 414, 420, 422, 425, 432, and 434; Acid Orange 3, 7, 10, 19, 33, 56, 60, 61, 67, 74, 80, 86, 94, 139, 142, 144, 154, and 162; Acid Blue 1, 7, 9, 15, 92, 133, 158, 185, 193, 277, 277:1, 314, 324, 335, and 342; Acid Green 1, 12, 68:1, 73, 80, 104, 114, and 119; Acid Black 1, 26, 52, 58, 60, 64, 65, 71, 82, 84, 107, 164, 172, 187, 194, 207, 210, 234, 235; and combinations of these. The acid dyes may be used singly or in any combination in the dye solution.

Acid dyes are commercially available from many sources, including Dystar L.P., Charlotte, N.C. under the trademark TELON®, Huntsman Corporation, Woodlands, Tex. under the trademarks ERIONYL® and TECTILON®, BASF SE, Ludwigshafen, Germany under the trademark BASACID®, and Bezema AG, Montlingen, Switzerland under the trade name Bemacid.

The acid dye solution may include from about 0.001 g/L to about 5.0 g/L, preferably from about 0.01 g/L to about 2 g/L, of the acid dye compound or combination of acid dye compounds. The amount of acid dye compound used will determine the strength of the color of the dyed polyurethane and how quickly the polyurethane may be dyed, and may be optimized in a straightforward manner; generally, a more concentrated dye solution can provide a stronger (deeper, darker, more intense) dyed color and can more quickly dye the polyurethane than a less concentrated dye solution.

The dye solution also may include a quaternary (tetraalkyl) ammonium salt selected from soluble tetrabutylammonium compounds and tetrahexylammonium compounds. The counter ion of the quaternary ammonium salt may be selected so that the quaternary ammonium salt forms a stable solution with the anionic dye. The quaternary ammonium compound may be, for example, a halide (such as chloride, bromide or iodide), hydroxide, sulfate, sulfite, carbonate, perchlorate, chlorate, bromate, iodate, nitrate, nitrite, phosphate, phosphite, hexfluorophosphite, borate, tetrafluoroborate, cyanide, isocyanide, azide, thiosulfate, thiocyanate, or carboxylate (such as acetate or oxalate). In certain embodiments, an anion that is a weaker Lewis base may be selected for the tetraalkylammonium compound to produce a darker color in the dyed article. In various embodiments, the tetraalkylammonium compound may be or may include a tetrabutylammonium halide or tetrahexylammonium halide, particularly a tetrabutylammonium bromide or chloride or a tetrahexylammonium bromide or chloride.

The acid dye solution may include from about 0.1 equivalents to about 5 equivalents of the soluble tetraalkylammonium compound per equivalent of dye compound. In various embodiments, the acid dye solution may include from about 0.5 equivalents to about 4 equivalents, from about 1 equivalent to about 4 equivalents of the tetraalkylammonium compound per equivalent of dye compound. The amount of tetraalkylammonium compound used with a particular acid dye compound depends upon the rate of diffusion of the dye into and in the polyurethane and may be optimized in a straightforward manner.

The dye solution may include a water-soluble organic solvent. Water solubility of a particular organic solvent used in a particular amount in the dye solution is determined at 20° C. and 1 atm. pressure at the concentration at which the organic solvent is to be used in the dye solution. An organic solvent is considered water soluble if it fully dissolves or is fully miscible in water at 20° C. and 1 atm. pressure at the concentration at which the organic solvent is to be used in the dye solution and if it does not form any separate phase or layer. Suitable non-limiting water-soluble organic solvents that may be used include alcohols, such as methanol, ethanol, n-propanol, isopropanol, ethylene glycol, diethylene glycol, triethylene glycol, tetraethylene glycol, propylene glycol, propylene glycol monomethyl ether, dipropylene glycol, tripropylene glycols, and glycerol; ketones, such as acetone and methyl ethyl ketone; esters, such as butyl acetate, which is soluble in limited amounts in water; and glycol ethers and glycol ether esters (particularly acetates), such as ethylene glycol monobutyl ether, propylene glycol monomethyl ether, and propylene glycol monomethyl ether acetate. The water-soluble organic solvent may be included in concentrations of up to about 50 percent by volume, or up to about 25 percent by volume, or from about 1 percent to about 50 percent by volume, or from about 5 percent to about 40 percent by volume, or from about 10 percent to about 30 percent by volume, or from about 15 percent to about 25 percent by volume, of the aqueous medium used to make the dye solution. Whether an organic solvent is used and how much organic solvent is used varies according to which dye is used and to the application method for contacting the dye solution with the polyurethane. For instance, no or minimal organic solvent may be included in a dye solution into which the polyurethane is dipped in dyeing the polyurethane, while substantially more organic solvent may be included when the dye is sprayed or printed onto the polyurethane.

For the purposes of this disclosure, the method will be described in detail as it relates to an article of footwear or a part of an article of footwear, such as a midsole or an air bladder. However, the user understands that articles of different intended use, size, shape, or composition of matter may be colored in accordance with the method disclosed herein. For example, toys, balls, key fobs, clothing, and other objects may be colored in accordance with embodiments of the disclosure. Further, the disclosure will be described in detail with regard to a footwear component that is multicolored or exhibits that color gradient so that the footwear component presents a pleasing appearance. For example, an article colored by an embodiment of a method described in detail herein may exhibit a gradient of a first color from a deep and saturated hue through light and unsaturated hue adjacent to a second color that has a gradient from a light and unsaturated hue through a deep and intensely saturated hue. This effect is very pleasing and subtly changes from the first color to the second color in a gradient. Colors also may be overlapped to form a third color.

The appearance of a color may be quantified or determined in many ways. One such way is to have an observer evaluate the colors. However, even a trained observer may not be able to evaluate colors so as to determine whether other observers will evaluate the colors in the same way.

Many color standards or color spaces, such as the CIELAB system, the CMC modifications of the CIELAB system, the Munsell Color System, the Pantone Matching System, and RGB color space, and a CYMK color space, are known. These are but a few of the many color standards and spaces used in color evaluation.

Consumer goods present a number of color issues. Matching a selected color may be important for a number of reasons. For example, consumers may seek to match colors of related products, such as shoed, shirts, and pants. Similarly, members of a team may seek to have essentially identically-colored shoes or clothing. Therefore, although quantifying or determining a color may be important, determining differences in colors, or whether colors are perceived as matching or as the same color, may be more important.

Thus, systems for determining and quantifying color differences have been developed. Such color systems may measure hue (i.e., perceived color, such as red, yellow, brown, or purple); chroma, also known as intensity or saturation, and lightness. Hue may be determined as a blend of shades. Each factor is important in color characterization. Because color matching is important, systems for determining differences between colors have been developed, and characterizations of color differences are available. For example, in the CIELAB system, a sample is compared to a standard, and differences in lightness (L*), red/green shade (a*), yellow/blue shade (b*), and saturation (C*) are determined. Differences in these values may be used individually or in combination to evaluate colors, i.e., to determine whether colors are considered to ‘match.’ A single value, DE, also may be calculated in accordance with known algorithms to determine a single value that may be used to represent the differences between the two colors. The magnitude of DE is an indicator of the magnitude of the color difference.

Consideration of whether 2 colors separated by a DE value represents a visually acceptable color difference can conveniently be made in the CMC system, which is particularly suited for automated evaluations on a pass/fail basis. In this system, which produces a value of DE(CMC), variations having a DE(CMC) value of 1.0 or less at a fixed ratio of lightness to chroma of 2:1 are considered to be acceptable. Under certain circumstances, larger or smaller DE(CMC) values may be more appropriate.

In this system, a hue value however, is calculated. This represents the color recognized by the human eye. Therefore, DH* represents the difference in hue. Similarly, C*, or difference in chroma, is a representation of differences in chromaticity, also called intensity or saturation. A negative DC* thus indicates that the compared color is less saturated than the sample color. Chroma is evaluated at a given hue. For convenience herein, a DE(CMC) of about 1.0 or less is considered an acceptable match, with values between about 0.9 and about 1.0 considered acceptable, but marginal.

As can be seen, this system also provides a convenient way of identifying differences in saturation. C* indicates such differences. Thus, to produce a gradient of color at 20 percent saturation internals, one would select colors that have essentially the same hues but have chromas that are 80 percent, 60 percent, 40 percent, and 20 percent of the saturated chroma. Thus, if the most saturated chroma is 30, the chromas, C*, of the gradient colors would be 24, 18, 12, and 6, respectively. Expressed alternatively, DC* values would be −6, −12, −18, and −24.

DE(CMC) and C* values are but one convenient way to evaluate colors and color matching. Any suitable system may be used in relation to this disclosure.

Articles of footwear generally include two primary elements: an upper and a sole system. The upper is often formed from a plurality of material elements (e.g., textiles, polymer sheet layers, foam layers, leather, and synthetic leather) that are stitched or adhesively bonded together to form a void on the interior of the footwear for comfortably and securely receiving a foot. More particularly, the upper forms a structure that extends over instep and toe areas of the foot, along medial and lateral sides of the foot, and around a heel area of the foot. The upper may also incorporate a lacing system to adjust the fit of the footwear, as well as permitting entry and removal of the foot from the void within the upper.

Sole systems can include one or more components or components. These can include outsoles, midsoles, insoles, inserts, bladders and/or airbags as well as possibly other articles or components.

For example, FIGS. 1 and 2 are perspective views of an embodiment of a multicolored article 100. Article 100 may generally be associated with a sole system or sole structure for an article of footwear. In some embodiments, for example, article 100 could comprise a bladder member or airbag that is incorporated into a sole system. In some embodiments, article 100 could be further attached to additional components of a sole system including an outsole, midsole, and/or insole. Moreover, it will be understood that article 100 could be used with any kind of sole system and type of footwear (e.g., running shoes, basketball shoes, football shoes, soccer shoes, boots, loafers, sandals, etc.).

Referring to FIGS. 1 and 2, article 100 may include front foot portion 102 and heel portion 104. In addition, article 100 includes a top side 106 (shown in FIG. 1) and a bottom side 118 (shown in FIG. 2). Top side 106 of article 100 would for instance be oriented toward a wearer's foot in an assembled shoe. Bottom side 108 may be oriented towards a lower or ground contacting portion of a shoe (such as an outsole). Article 100 may further include peripheral edge 108 of article 100 is also partially shown. In some embodiments, peripheral edge 108 may be visible in an assembled sole of an athletic shoe.

In different embodiments, article 100 could have one or more colors. In the present embodiment, article 100 may be provided with at least two distinct colors, first color 110 on heel portion 104 and second color 112 on front foot portion 102. As an example, first color 110 could be yellow, while second color 112 could be blue. However, this example is only one of many possible color combinations and it will be understood that first color 110 and second color 112 could be any colors. The sizes of the portions may be the same or different. In some embodiments, the portions are different sizes.

Some embodiments can incorporate transition areas between portions of different colors. In one embodiment, a transition area 114 can be disposed between heel portion 104 and front foot portion 102. In some embodiments, transition area 114 can be a blend of color 110 and color 112.

As seen in FIGS. 1 and 2, first color 110 and second color 112 permeate through article 100 so as to be visible from top side 106 or bottom side 118. Likewise first color 110 and second color 112 may be visible from peripheral edge 108. Although only one side of peripheral edge 108 is shown in FIGS. 1 and 2, it will be understood that the opposing side of peripheral edge 108 may have a substantially similar color pattern.

In some embodiments, transition area 114 can be omitted. Instead, a line of demarcation between two colors could be visible. In other embodiments, only one color may be used to color article 100. In still other embodiments, three or more distinct colors could be used, with or without transition areas between adjacent distinct colors.

Embodiments can include provisions to facilitate coloring an article to achieve the multicolor effect shown in FIGS. 1 and 2 (as well as other possible color schemes). In embodiments where an article is colored using a dye, for example, a system and associated method can include provisions to dye portions of the article, rather than the entire article.

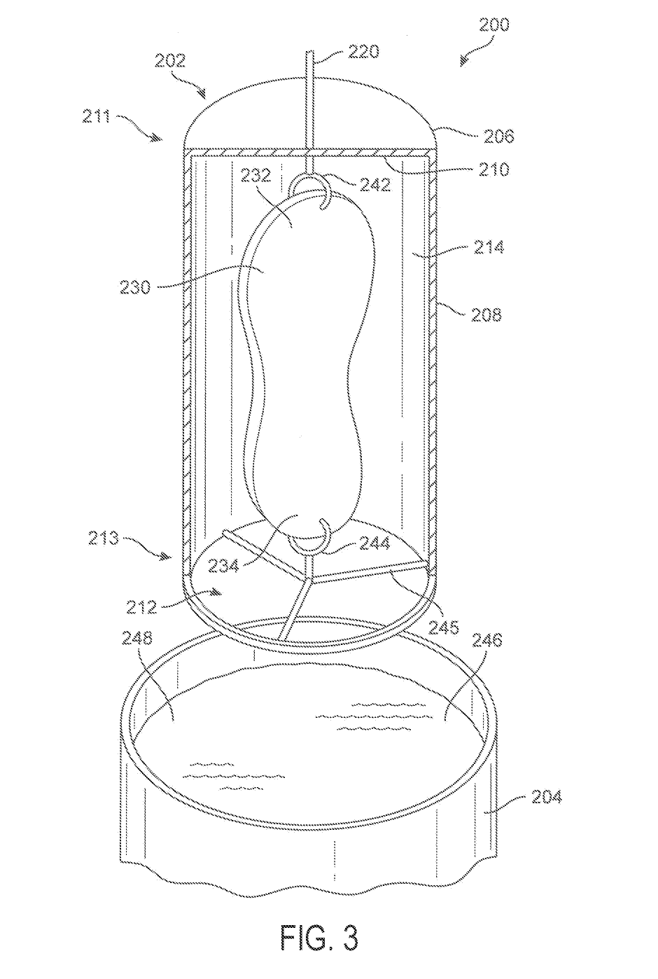

In accordance with embodiments of the invention, article 100 is colored by dipping heel portion 104 into tank 204, as illustrated in FIG. 3. FIG. 3 is a cutaway isometric view of an embodiment of an apparatus 200 used to produce multicolored article 100 such as shown in FIGS. 1 and 2. Apparatus 200 may include assembly 202, tank 204, and provisions for maneuvering assembly 202 with respect to tank 204. As discussed in further detail below, assembly 202 is configured to retain an article, while tank 204 may be filled with a liquid coloring agent to be applied to the article.

In some embodiments, assembly 202 may further include a container 206. Container 206 may include a side wall 208. In some embodiments, container may be closed at a first end portion 211 and open at a second end portion 213. In one embodiment, container 206 can include a top wall 210 at first end portion 211 and a bottom opening 212 at second end portion 213. Bottom opening 212 may provide access to an interior 214, which is bounded by side wall 208 and top wall 210.

In different embodiments, the geometry of container 206 could vary. In the exemplary embodiment shown in the figures, container 206 has an approximately cylindrical shape. More specifically, side wall 208 may be a cylindrical wall, while top wall 210 may be circular. However, in other embodiments, container 206 could have any other geometry including, but not limited to: a spherical geometry, a pyramidal geometry, a rectangular prism geometry, or any other three-dimensional geometry (including both regular and irregular geometries).

Tank 204 may be configured to retain liquid coloring agent 246. Here, liquid coloring agent 246 may be associated with color 248. For purposes of illustration, tank 204 is shown as having a cylindrical geometry. However, the geometry of tank 204 may be different in other embodiments.

Embodiments may include provisions to position container 206. In some embodiments, apparatus 200 includes actuator 220 which may be used to adjust the position of container 206 relative to tank 204. In some embodiments, actuator 220 could be used to raise and lower container 206 with respect to tank 204. For purposes of illustration, only a portion of an actuator that is in contact with container 206 is shown in the figures. Any suitable type of mechanism can be used to raise and lower container 206. Some examples of devices that may be so used include linkages, pulley system, ropes, and cables, which may be mechanized or operated manually, for example.

In order to fasten an article within container 206, assembly 202 may include one or more retaining members, which may also be referred to as fastening members. In the exemplary embodiment, upper retaining member 242 and lower retaining member 244 are provided inside container 206. In particular, upper retaining member 242 may be secured to top wall 210 of container 206. In some embodiments, a retaining member bracket 245 secures lower retaining member 244 to a lower portion of side wall 208. In the example shown, an article 230 is positioned vertically within container 206. Specifically, front foot portion 232 of article 230 is secured in container 206 by upper retaining member 242. Also, heel portion 234 of article 230 is secured in container 206 by lower retaining member 244.

First retaining member 242 and second retaining member 244 may be any suitable means for retaining article 230 inside container 206 in a secure position. The embodiment illustrated in the drawing figures is particularly useful for buoyant articles. Some embodiments may employ clips, clamps, tension rods, hooks, or brackets as retaining members. Still other embodiments may use any other kinds of retaining members known in the art for temporarily fixing or holding an article in place.

As seen in FIG. 3, container 206 may be arranged in an inverted position with respect to tank 204. In particular, second end portion 213, which includes bottom opening 212, is disposed closer to tank 204 than first end portion 211. As described in further detail below, this arrangement allows liquid coloring agent 246 to partially fill interior 214 as container 206 is lowered into tank 204.

In FIG. 3, an embodiment of the assembly 202 is depicted before introducing container 206 into tank 204. Article 230, in an uncolored/un-dyed state, is shown disposed inside inverted container 206. In this particular configuration, article 230 is retained at front foot portion 232 and at heel portion 234.

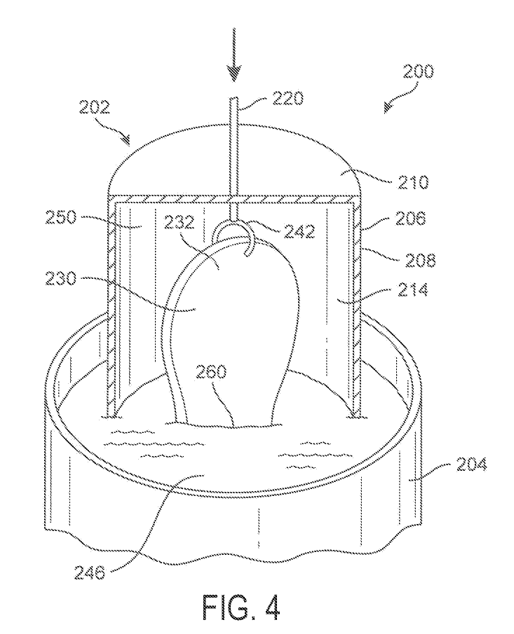

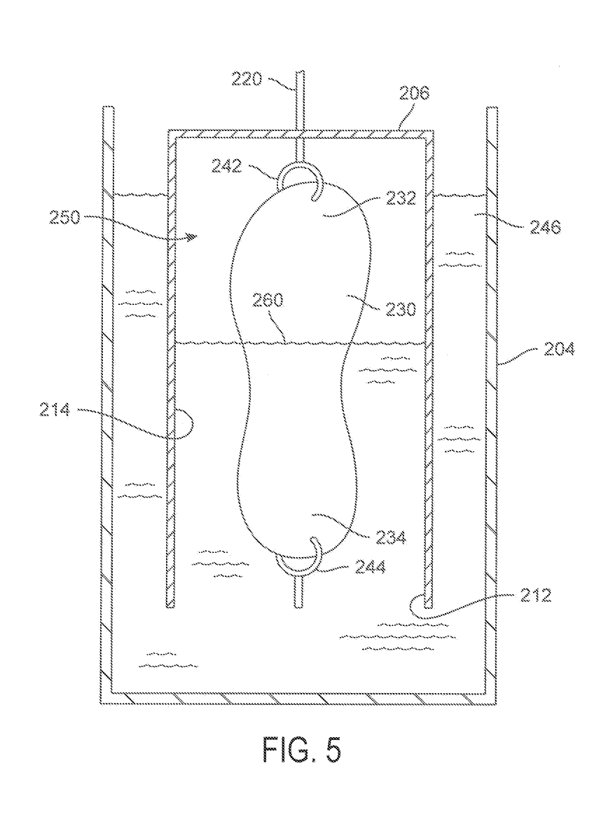

FIGS. 4 and 5 show an embodiment of assembly 202 in a process of lowering container 206 into tank 204. As discussed above, tank 204 may be filled with liquid coloring agent 246. In some embodiments, liquid coloring agent 246 may comprise a liquid dye. In some embodiments, liquid coloring agent 246 may be a liquid dye with color 248.

Referring to FIG. 4, actuator 220 lowers container 206 into tank 204 as indicated by a downward pointing arrow. As container 206 is lowered, a portion of container 206 is introduced into tank 204. Bottom opening 212 of container 206 allows for liquid coloring agent 246 to enter interior 214 of container 206.

Air pocket 250 is created as container 206 is lowered into tank 204. In particular, as bottom opening 212 of container 206 comes into contact with liquid coloring agent 246, air within interior 214 of container 206 becomes trapped (or sealed) within container 206. Specifically, the air within interior 214 is captured within the volume bounded by top wall 210, side wall 208, and the surface of liquid coloring agent 246.

In the configuration of FIG. 4, article 230 is shown as partially dipped into liquid coloring agent 246. Heel portion 234 (not visible) is submersed in the liquid coloring agent 246. However, front foot portion 232 in disposed above the surface of liquid coloring agent 246 and within air pocket 250.

In some embodiments, article 100 may be buoyant. For example, in embodiments where article 230 is a bladder member or airbag, article 230 may be especially buoyant and resist being submerged in a liquid. Therefore, upper retaining member 242 and lower retaining member 244 may prevent article 230 from floating while being dipped into liquid coloring agent 246. This arrangement allows open bottom 212 of container 206 to be at least partially submersed below a liquid level in tank 204.

As seen in FIG. 5, the liquid level 260 (also shown in FIG. 4) of liquid coloring agent 246 within the container 206 may vary with the volume of air pocket 250. The volume of air pocket 250 may vary with the depth of submersion of container 206 within tank 204. In particular, as container 206 is further submerged, the volume of air pocket 250 may be further compressed. In some embodiments, the volume of air pocket 250 may be controlled independently from the submersion depth by using other provisions to increase the pressure within air pocket 250 and thereby maintain an approximately constant volume, or may otherwise change the volume of air pocket 250.

With container 206 submerged to a predetermined level within tank 204, liquid level 260 defines the transition between a first portion of article 230 that is outside of liquid coloring agent 246 and a second portion of article 230 submerged within liquid coloring agent 246. Here, the first portion is front foot portion 232 while the second portion is heel portion 234. In other embodiments, however, the first portion and the second portion could be any other portions. By holding container 206 at this depth for a predetermined short period, heel portion 234 of article 230 can be colored by liquid coloring agent 246. In this case, container 206 is shown as mostly, but not entirely submerged within liquid coloring agent 246. In other embodiments, container 206 could be completely submerged within liquid coloring agent 246.

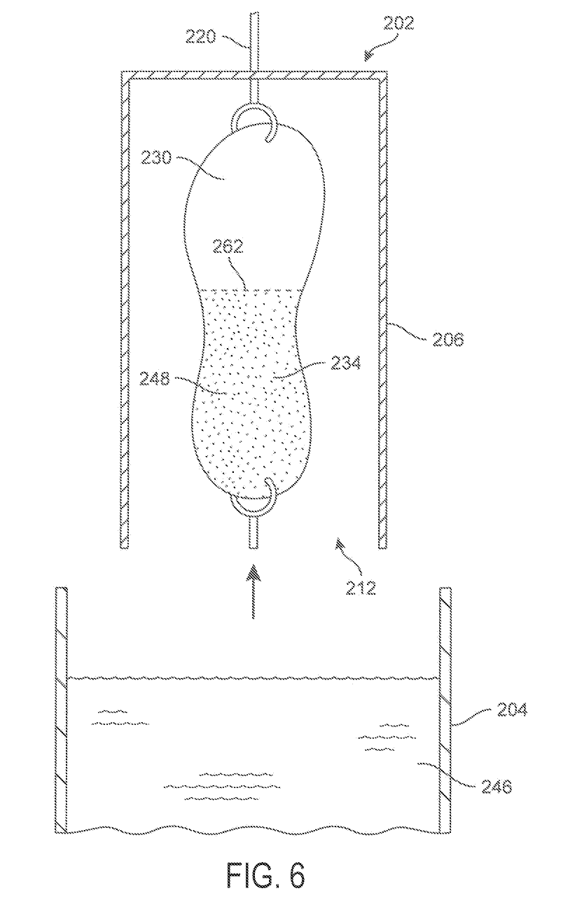

FIG. 6 illustrates an embodiment of container 206 being raised from tank 204 through the use of actuator 220. As container 206 is raised, liquid coloring agent 246 can exit container 206 through bottom opening 212. Dipped article 230 is shown having color 248 on heel portion 234 below coloring line 262. In embodiments of the disclosure, article 230 is dipped into tank 204 and removed to dry in at least 1 dip/dry cycle, to impart a selected color and saturation to heel portion 234 of article 230.

In accordance with embodiments of the disclosure, article 230 may be dipped into liquid colorant 246 in container 206 for a short period sufficient to impart color having a low saturation and insufficient to fully color the article to the selected saturation. In embodiments of the disclosure, the period for which the article 230 is immersed into liquid colorant 246 is between about 5 seconds and about 120 seconds, between about 10 seconds and about 60 seconds, and even between about 15 seconds and about 50 seconds, and between about 15 seconds and about 45 seconds. Article 230 then may be removed from liquid colorant 246 in container 206 and dried. Article 230 then may be again dipped and dried for as many times as is necessary to achieve the selected saturation in accordance with the dip/dry method of the disclosure.

The user recognizes that dip time for coloring under known methods may exceed at least about 5 minutes, at least about 30 minutes, and at least about 60 min, to achieve 100 percent saturation. However, in accordance with embodiments of the disclosure, wherein article 230 is repeatedly dipped into colorant 246 in container 206 for a short period, removed from the colorant, and dried, may achieve the selected color saturation in significantly less time than a single dip/dry cycle.

In embodiments of the disclosure, article 230 may be dipped the same distance in the colorant 246 in container 206 in each dip of a dip/dry cycle. In such embodiments of the disclosure, article 230 then may be colored to achieve an area of color having an essentially constant saturation, i.e., a block of color. Such a block of color is illustrated at FIG. 6, which shows article 230 having color 248 on heel portion 234.

In other embodiments of the disclosure, article 230 may be dipped to a lesser depth with successive dips in a series of dip/dry cycles. Each successive dip into colorant 246 in tank 206 may be to a shorter distance or lesser depth in such a series of drip/dry cycles. Thus, if the first dip is to a depth or distance of X millimeters, the second dip is to Y millimeters, wherein Y is less than X. In accordance with this embodiment of the disclosure, a gradient in a single color is imparted to article 230. This embodiment of the disclosure affords the opportunity to impart a subtle or indistinct gradient by dipping the article 230 into colorant 246 in container 206 to a depth that is a significant fraction of the previous dip depths. In such embodiments of the invention, the relationship of successive dip depths may be random, linear, geometric, or any relative distances. With the guidance provided herein, the user can select a program of dip depths that provide a selected pattern or arrangement.

In embodiments of the invention, a gradient may be established over selected distance of an article and may be applied over that length. For example, a gradient may be established over distance and may have 5 different saturations such a gradient may be achieved by dipping article 230 into colorants 246 in container 206 five times, reducing the dip depth with each successive dip. FIG. 14 illustrates such an embodiment. Thus, after a first dip for a time to a depth such as that illustrated by color line 1462 in FIG. 14 and a drying period, the second dip may be to a lesser depth, such as that illustrated by color line 1464 in FIG. 14. After a second the drying period, the next dip may be for the same or a different time to a depth illustrated by color line 1466 in FIG. 14. Successive dips to color lines 1468 and 1470, with appropriate drying periods therebetween, complete the 5 step gradient. As the skilled practitioner recognizes, this result may be achieved in any series of dip/dry cycles wherein different dip depths may be used. For example the article may be dipped twice to each depth, or 5 times to each depth, to achieve a gradient.

FIG. 14 illustrates a 5 step gradient. With essentially equal dip times, the gradient may range from 20 percent in first segment 1451, 40 percent in second segment 1452, 60 percent in third segment 1453, 80 percent in fourth segment 1454, and 100 percent in fifth segment 1455. In such an embodiment, these percentages are the percent of the deepest saturation on the article. Thus, fifth segment 1455 may have a saturation of 45 percent. In that case, first segment 1451 would have a saturation of 9 percent.

FIG. 14 illustrates an even gradient. In some embodiments of the disclosure, the number of dip/dry cycles for each segment need not be the same. Such an embodiment would yield a 5 step gradient with uneven color transition.

In another embodiment of the disclosure, a 100-step linear color gradient may be implemented on an article to present a gradual and subtle color gradient. With the guidance provided herein, the user will be able to determine the number of steps appropriate in a gradient to provide a selected presentation or appearance.

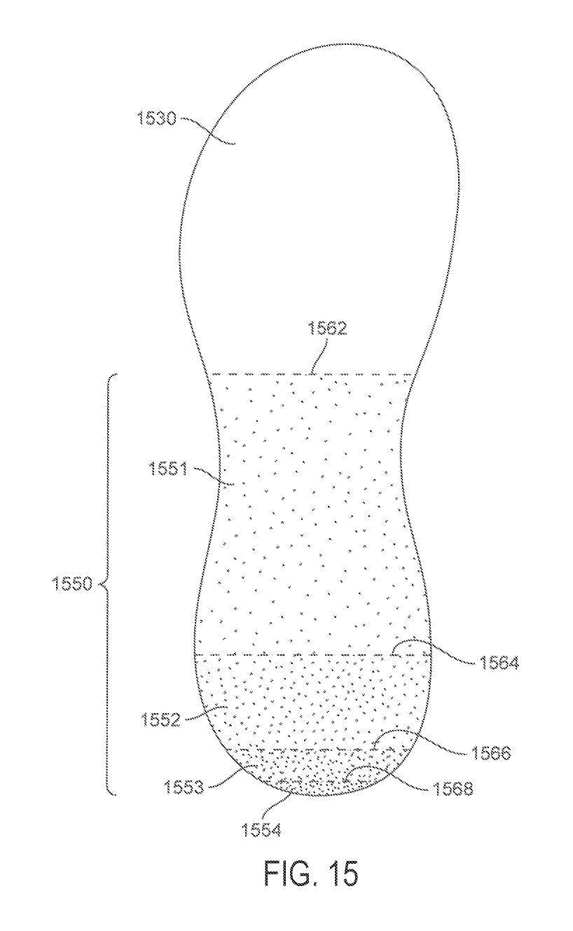

In some embodiments of the disclosure, the difference of dip depths need not be equal. Whereas dip depth differences are equal in FIG. 14, FIG. 15 illustrates unequal dip depths. The dip depths in FIG. 15 are related as the geometric progression 1, 3, 9, and 27. Thus, gradient section 1550 is divided into first segment 1551, second segment 1552, third segment 1553, and fourth segment 1554. The relative length of fourth segment 1554 is 1; third segment 1553, 3; second segment 1552, 9; and first segment 1551, 27. FIG. 15 illustrates the same relative number of dip/dry cycles, thus yielding a saturation in first segment 1551 of 25 percent, with 50 percent saturation in second segment 1552, 75 percent saturation in third segment 1553, and 100 percent saturation in fourth segment 1554. Again, the saturation percentages here are the percent of the deepest saturation on the article.

In some embodiments of the disclosure, changes in color saturation between segments are not based on single dips or equal dip times. For example, an article may be dipped to the same depth more than once while being dipped to other depths only once. This difference will change the relationships between the saturations in color segments. For example, after a dip to a selected depth and a drying period, the next dip cycle to a lesser depth may be carried out twice, with the next dip to a still lesser depth. This will provide a different relationship in saturation between color segments.

In embodiments of the disclosure, the saturation may not be directly proportional to the number of dip/dry cycles. For example, the relationship between saturation and number of dip/dry cycles may be linear or any increasing function. The relationship for any combination and dye can be determined by subjecting an article having the selected composition of matter to a series of dip/dry cycles and measuring saturation at the end of each cycle. Thus, with the guidance provided herein, the user can determine the relationship between saturation and number of dip/dry cycles.

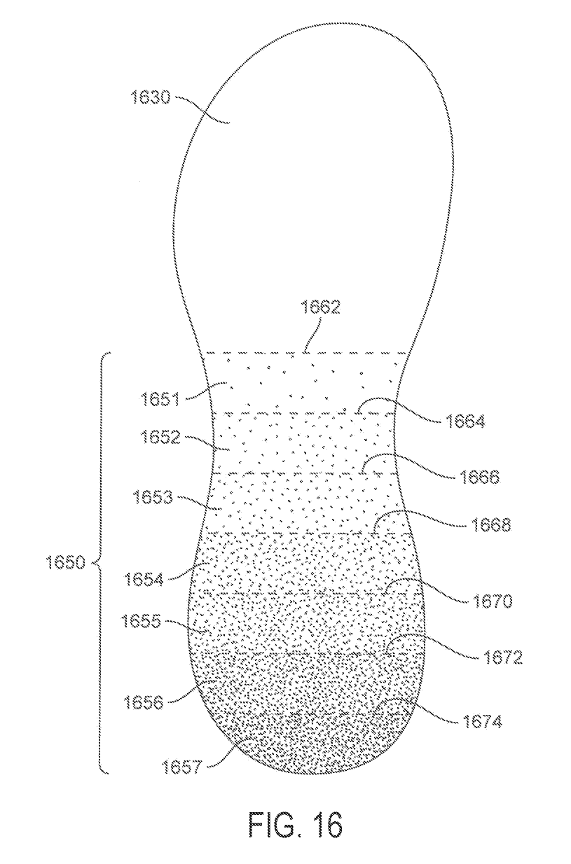

FIG. 16 illustrates an article that has varying relationships between saturations of color segments. Color segment 1650 of article 1630 is divided into seven color segments, each having an equal width on article 1630. Table 1 below identifies the relative number of dip/dry cycles, cumulative numbers of dip/dry cycles, and the percent saturation imparted to each of the color segments. The number of dip/dry cycles can be multiplied by any number to obtain the actual number of dips in each segment. For example, if color segment 1651 had 5 dips, color segment 1652 has 10 dips to that depth. As can be seen in FIG. 16 and Table 1, the change in saturation from a color segment to a succeeding color segment may vary between the color segments.

TABLE 1

| Upper | Lower | | | | |
|---|---|---|---|---|---|
| color | color | Color | Number of dips | | |
| line | line | segment | Relative | Cumulative | % Saturation |
| 1662 | 1664 | 1651 | 1 | 1 | 10 |
| 1664 | 1666 | 1652 | 2 | 3 | 30 |
| 1666 | 1668 | 1653 | 1 | 4 | 40 |
| 1668 | 1670 | 1654 | 2 | 6 | 60 |
| 1670 | 1672 | 1655 | 1 | 7 | 70 |
| 1672 | 1674 | 1656 | 2 | 9 | 90 |
| 1674 | End | 1657 | 1 | 10 | 100 |

With the guidance provided herein, the user can select conditions expected to provide a selected gradient.

In some embodiments of the disclosure, the article to be colored may be dipped into colors in alternate dip/drying cycles to impart the look of a third color. For example, a first dip of an article to a depth may be into a first colorant, such as green, to provide a green color section with low saturation on the article. Thereafter, the article may be dipped to the same or a different depth in a blue colorant to form a blue/green color segment where the article was exposed to both colorants, and to a blue color segment or a green color segment where the colorants do not overlap.

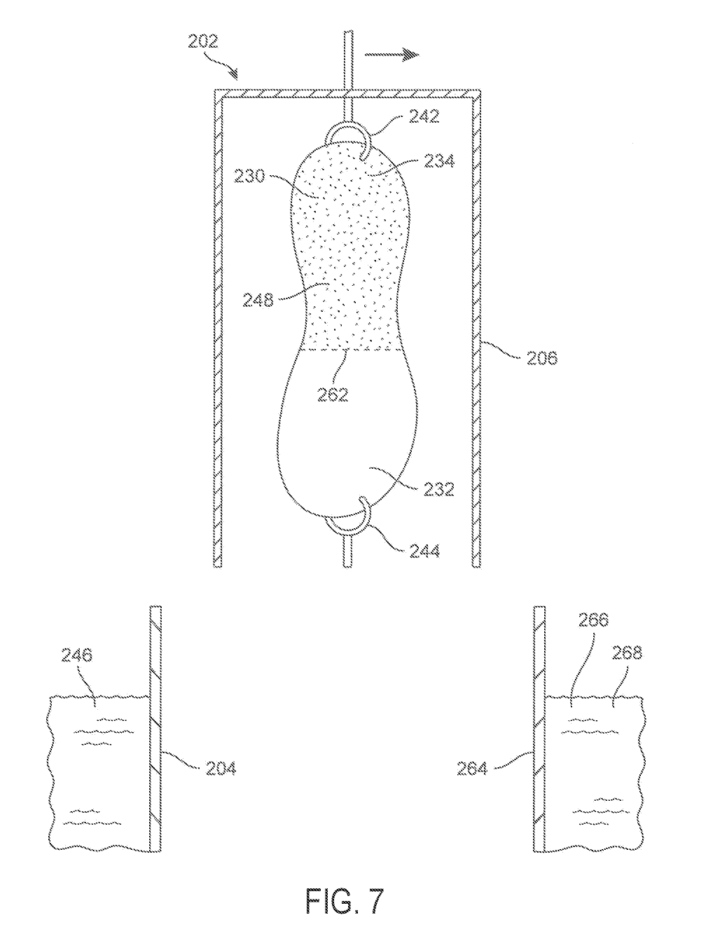

Article 230 may be inverted or reversed from the previous position. For example, in FIGS. 3-6, article 230 was oriented with heel portion 234 down and colored at that end. In other embodiments of the disclosure, two separate portions of an article may be dipped into different colors. FIGS. 7 through 9 illustrate schematic views depicting several additional steps that may be used to produce a multicolored article, according to an embodiment. It will be understood that these steps are optional and some embodiments may not include them, especially in embodiments where only a single color is desired.

Referring now to FIG. 7, article 230 may be inverted within container 206, with respect to the position of article 230 shown in the previous figures (e.g., FIG. 6). Thus, heel portion 234 is now secured in container 206 by upper retaining member 242. Also front foot portion 232 of article 230 is secured in container 206 by lower retaining member 244. Inverting the article 230 prepares the un-colored front foot portion 232 for dipping into next tank 264.

As also shown in FIG. 7, assembly 202 may be moved/transferred from tank 204 toward next tank 264. This is indicated by the horizontal arrow that is representative of any means for moving assembly 202, such as a conveyer device. This can occur before, after, or during the inversion of article 230 within container 206. Tank 264 may be filled with a liquid coloring agent 266 of color 268. In some embodiments, liquid coloring agent 266 may be a liquid dye. In an exemplary embodiment, color 268 is different from color 248.

In some embodiments any type of mechanism capable of transferring assembly 202 from tank 204 to next tank 264 can be employed. Some examples of possible of devices include, but are not limited to, linkages, pulley systems, ropes, cables, and other devices, which may be mechanized or manually operated, for example.

In some embodiments, additional dips of the article may be performed in the same or additional tanks. Additional dips can be for rinsing, coating, or sealing the article, for example. Furthermore, some embodiments can include drying operations in between dips of the article. These additional dips or operations can occur before, between, or after the dips of the articles as set forth above. Each dip may be associated with a drying period.

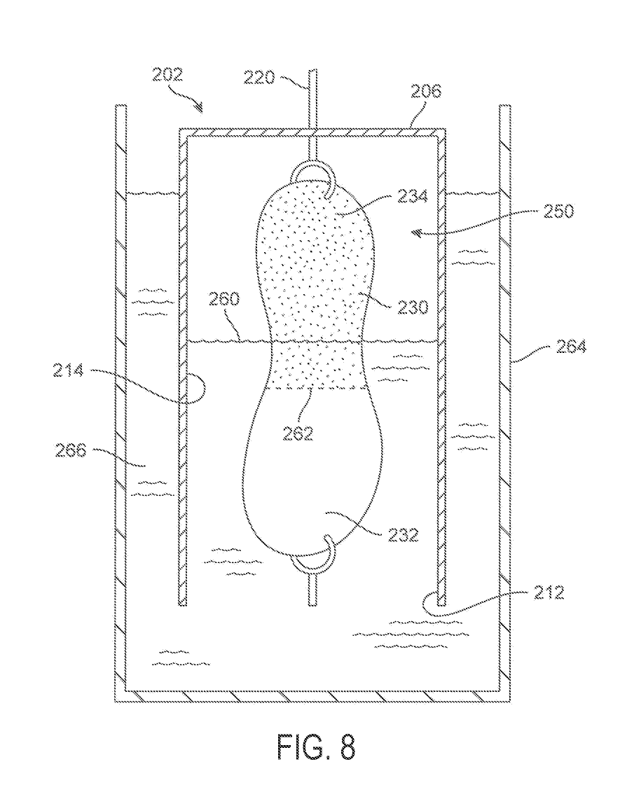

FIG. 8 shows an embodiment of assembly 202 lowering container 206 into next tank 264. This illustrates a second lowering or dipping of container 206 to dip the un-colored front foot portion 232 of article 230 into next tank 264. In this step, actuator 220 lowers container 206 into tank 264 that is filled with liquid coloring agent 266. Open bottom 212 of container 206 allows for liquid coloring agent 266 to enter interior 214 of container 206. As described previously, air pocket 250 is created as container 206 is lowered into tank 264. In this arrangement, heel portion 234 is shown as being disposed in air pocket 250. In other words, heel portion 234 is not in contact with liquid coloring agent 266.

In the embodiment shown, front foot portion 232 of article 230 is shown as partially dipped into liquid coloring agent 266. In some embodiments, article 230 could be submerged to a point where coloring line 262 is submerged below liquid level 260. This allows some portions of article 230 that have already been colored with color 248 to be additionally colored with liquid coloring agent 266. As discussed below, this creates a color transition region that is a blend of color 248 and color 268. However, in other embodiments, coloring line 262 could be disposed above liquid level 260, such that no portion of article 230 is colored more than once.

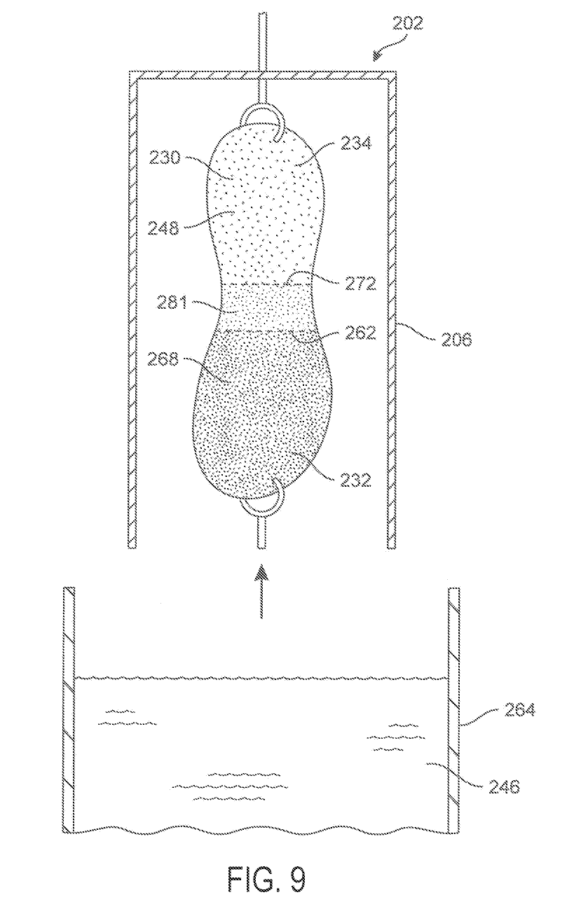

FIG. 9 illustrates an embodiment of assembly 202 after the step of dipping container 206 into tank 264. Referring to FIG. 9, dipped article 230 is shown having color 268 on front foot portion 232 below coloring line 262, and color 248 on heel portion 234 above coloring line 272. Coloring line 262 is made while dipping article 230 in tank 204. Coloring line 272 was made when dipping article 230 in tank 264. According to an exemplary embodiment, article 230 is dipped once into tank 264 to dye front foot portion 232 of article 230.

Additionally, in this embodiment, dipped article 230 has a color transition portion 281, which is disposed between coloring line 262 and coloring line 272. Transition portion 281 comprises a blend of color 248 and color 268.

As previously described, in some embodiments article 230 can be dipped any number of times to achieve different coloring effects. Dipping an article multiple times can be used to achieve desired results in color saturation, to provide color transition areas, etc. In some cases, the volume of air pocket 250 within container 206 can be varied in successive multiple dips to achieve varying results.

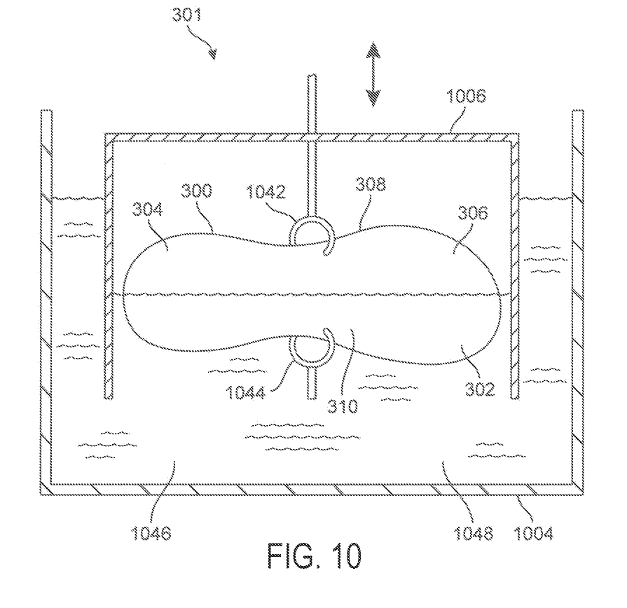

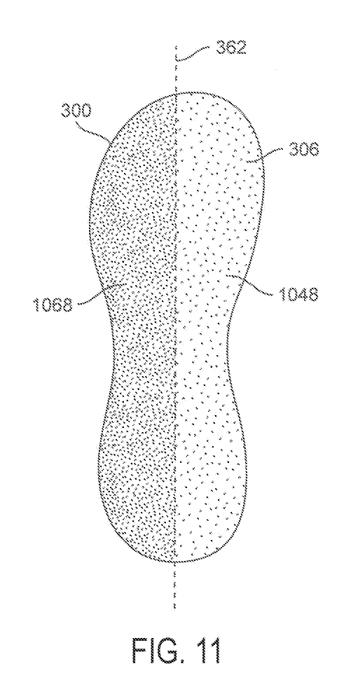

In embodiments of the disclosure, articles may be oriented in any position. For example, as shown in FIGS. 3-9, the heel portion and the toe portion of a footwear article are illustrated. However, FIG. 10 depicts an embodiment having an alternative retaining position of article 300. In the example shown, article 300, which includes a front foot portion 302 and a heel portion 304, is positioned horizontally, rather than vertically as in the previous embodiment. Top side 306 of article 300 is viewed in the plane of the drawing. In this configuration, a lateral peripheral edge portion 308 of article 300 is secured in container 1006 by upper retaining member 1042. Medial peripheral edge portion 310 of article 300 is secured in container 1006 by lower retaining member 244.

Embodiments of the disclosure relating to the method are essentially the same for any application of any color to an article. Assembly 301 is shown being lowered into tank 1004 filled with liquid coloring agent 1046 of color 1048 for example. The process for coloring article 300 is repeated according to the previous exemplary embodiment discussed above and shown in FIGS. 3 through 8. However, it will be understood that article 300 in the present embodiment is inverted in the container 1006 in a manner (not shown) such that when inverted medial peripheral edge portion 310 is secured in container by upper retaining member 1042. Further, lateral side peripheral edge portion 308 of article 300 is secured in container by lower retaining member 1044 in the inverted position. Container 1006 is then transferred and submerged into another tank for applying another color.

These embodiments show some possible orientations for an article with respect to the surface of a liquid coloring agent. In particular, the embodiments depict configurations where the article may be vertical to the surface (e.g., FIG. 5) or horizontal (e.g., FIG. 10). In other embodiments, the position of the article can be angled relative to the liquid coloring agent surface, rather than being vertically or horizontally oriented.

FIG. 11 shows an embodiment of resulting article 300 according to the above described production steps. Multi-colored article 300 is shown with top side 306 viewed in the plane of the drawing. On a medial side of coloring line 362, article 300 is dyed with color 1048. On a lateral side of coloring line 362, article 300 is dyed with another color 1068. Although no transition area is shown, it will be understood that a transition area blending color 1048 and color 1068 could be provided to the medial and lateral sides of coloring line 362. Furthermore, since the colors permeate the article, the colors are visible from the top side 306, bottom side (not shown), and peripheral edges (not shown).

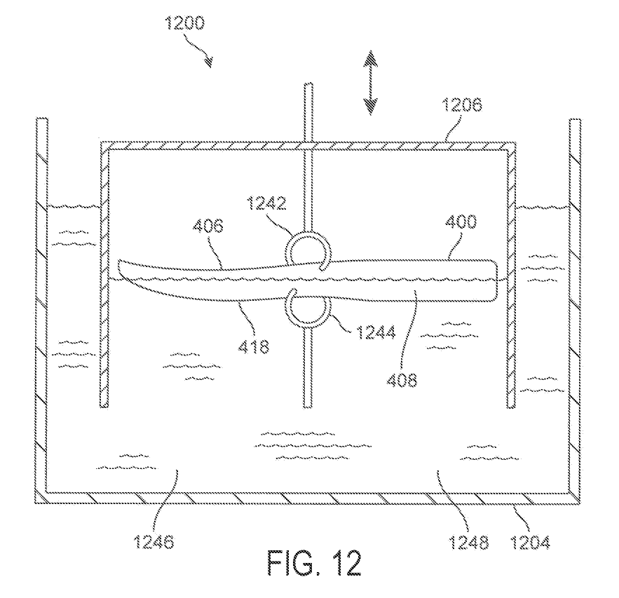

FIG. 12 illustrates a variation for an embodiment having another alternative retaining position of article 400. In the example shown, the article 400 is again positioned horizontally. However, a side view of article is shown. Peripheral edge 408 is in the plane of the drawing. Top side 406 of article 400 is secured in container 1206 by upper retaining member 1242. Bottom side 418 of article 400 is secured in container 1206 by lower retaining member 1244.

Assembly 1200 is shown lowered into tank 1204 filled with liquid coloring agent 1246 of color 1248, for example. The process for dying article 400 is repeated according to the first exemplary embodiment discussed above and shown in FIGS. 3 through 8. However, it will be understood that article 400 in the present embodiment is inverted in container 1206 in a manner (not shown) such that bottom side 418 is secured in container 1206 by upper retaining member 1242. Further, top side 406 of article is secured in container 1206 by lower retaining member 1244. Container 1206 can then transferred and submerged into another tank.

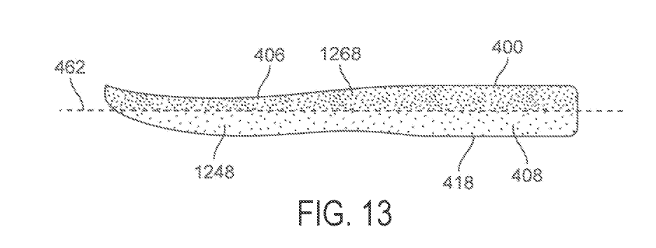

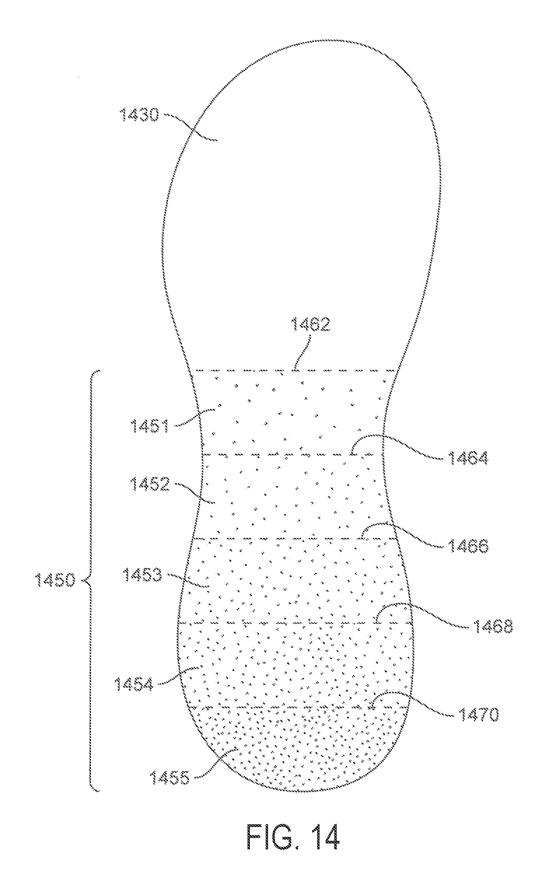

FIG. 13 shows an embodiment of resulting article 400 according to the above described steps. Multi-colored article 400 is shown with peripheral edge 408 visible. Bottom side 418 of article 400 is dyed with color 1248 below coloring line 462. Top side 406 of article 400 is dyed with color 1268 above dye line 462. Although no transition area is shown, it will be understood that a transition area blending color 1248 and color 1268 could be provided above and below coloring line 462. Furthermore, since the dye colors permeate the article, the colors are visible from the top side 406, bottom side 418, and peripheral edge 408.

Embodiments can include provisions for coloring multiple articles simultaneously within a single tank of liquid coloring agent. For example, some embodiments could include provisions for retaining multiple articles at the same height within a container, thereby allowing the multiple articles to be colored simultaneously. As another example, some embodiments could incorporate assemblies with stacked containers, where one or more articles can be colored within each container, and where the entire assembly could be submerged into a tank of liquid coloring agent.

Although embodiments of the disclosure have been illustrated with detail in FIGS. 3-13 as dipping a single article into a single tank, other dipping arrangements may be used. For example, FIGS. 3-13 illustrate an apparatus particularly suitable for retaining the dipped portion of an article below the surface of a liquid colorant. Thus, the article in these drawings may be buoyant in liquid colorant, but the retainers ensure that the article is properly dipped. Such retainers also may be useful for separating multiple items dipped simultaneously so that they do not contact each other and preclude appropriate interaction between colorant and article.

Embodiments of methods of this disclosure may be found in United States Published Patent Application 2014/0250735, published Sep. 11, 2014, entitled METHOD OF MAKING MULTI-COLORED OBJECTS, the entirety of which is hereby incorporated by reference.

Embodiments of the disclosure may be practiced in many apparatus having the ability to dip and the dry and article as described herein. One such apparatus is described in detail in United States Published Patent Application 2014/0250610, published Sep. 11, 2014, entitled SYSTEM AND METHOD FOR COLORING ARTICLES, the entirety of which is hereby incorporated by reference.

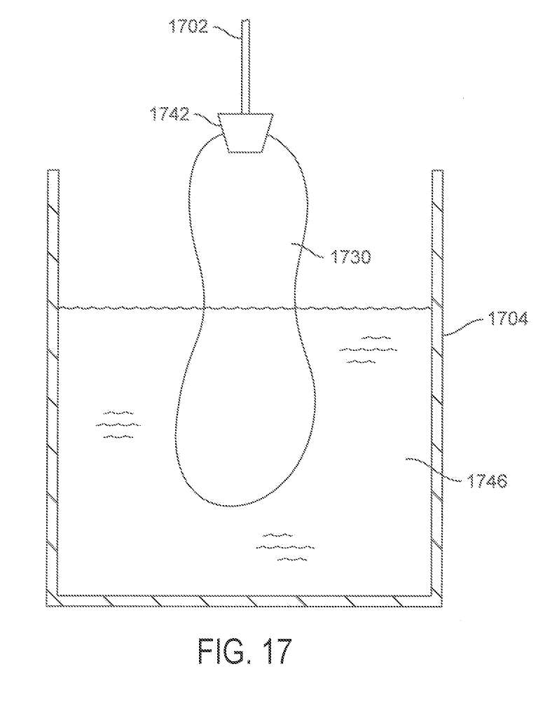

FIG. 17 illustrates another embodiment of the disclosure in which retaining member 1742 may retain article 1730 above liquid colorant 1746 in a manner that enables dipping of article 1730 into liquid colorant 1746 without having article 1730 float on liquid colorant 1746. FIG. 17 shows at least part of article 1730 in liquid colorant 1746 in tank 1704, which also may be called a dye tank. For example, in some embodiments of the disclosure, article 1730 may not be buoyant in liquid colorant 1746. In some embodiments of the disclosure, article 1730 may be buoyant but sufficiently rigid as to not float when held in liquid colorant 1746 by retaining member 1742. In some embodiments of the disclosure, retaining member 1742 retains rigid article 1730 by gripping with force sufficient to essentially preclude article 1730 from floating or otherwise be unsatisfactorily dipped. With the guidance provided herein, the user can determine whether an article may be suitably retained in a single retaining member for coloring in accordance with embodiments of the disclosure.

An embodiment of FIG. 17 is particularly effective for coloring articles that may be dipped into a liquid colorant when held at a point above the liquid colorant. FIG. 17 depicts part of article 1730 dipped into liquid colorant 1746 in tank 1704. Actuator 1702 may be moved vertically downward, as indicated by the arrow, to dip article 1730 into liquid colorant 1746 in tank 1704. Article 1730 then may be removed from liquid colorant 1746 by moving actuator 1702 vertically upward, as indicated by the arrow. In some embodiments of the disclosure, article 1730 may be dipped repeatedly into liquid colorant 1746 and dried until a selected saturation is achieved.

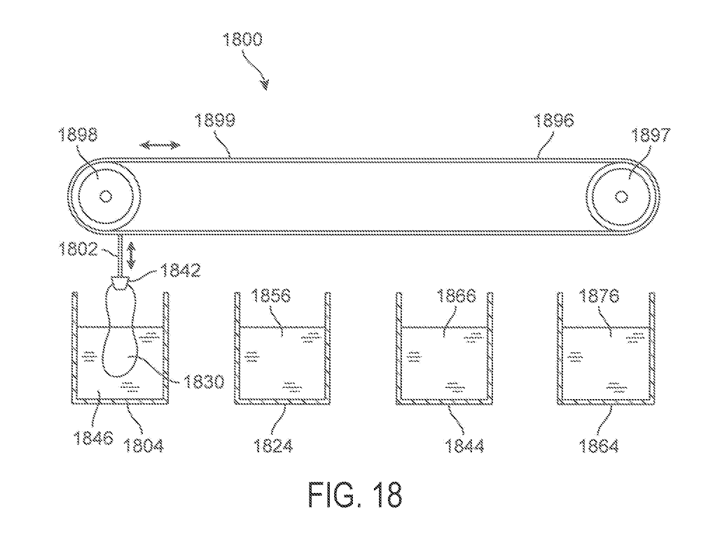

In embodiments of the disclosure, an article may be dipped sequentially in different liquid colorants or in different fluids, such as washes between dips in liquid colorant and drying periods. FIGS. 18-21 illustrate an embodiment of a disclosure of sequential dip/dry cycles. These figures illustrate the processing of an article in relationship to a plurality of tanks containing processing fluid.

Turning now to FIG. 18, actuator 1802 may be attached to conveying device 1899. Conveying device 1899 comprises continuous belt 1896 between powered pulley 1898 and pulley 1897 and may convey or translate actuator 1802 above first tank 1804, second tank 1824, third tank 1844, and fourth tank 1864, as indicated by the arrow. In embodiments of the disclosure, there may be any number of tanks over which conveying device 1899 may convey, move, or translate actuator 1802 and equipment and articles associated therewith.

In accordance with embodiments of the disclosure, article 1830 is held in retaining member 1842 on actuator 1802 above liquid colorant 1846 in first tank 1804. Actuator 1802 then may be activated to move retaining member 1842 in the direction of the arrow toward liquid colorant 1846 until article 1830 is at least partially submersed in liquid colorant 1846, as illustrated in FIG. 18. After a selected short period, actuator 1802 moves retaining member 1842 with article 1830 therein upwardly in the direction of the arrow to remove article 1830 from liquid colorant 1846. Article 1830 then may be allowed to dry while suspended over first tank 1804 or may be moved or translated to a position over another tank. In embodiments of the disclosure, article 1830 may be dipped into liquid colorant 1846 and dried in a plurality of sequential cycles before being moved to a position over another tank.

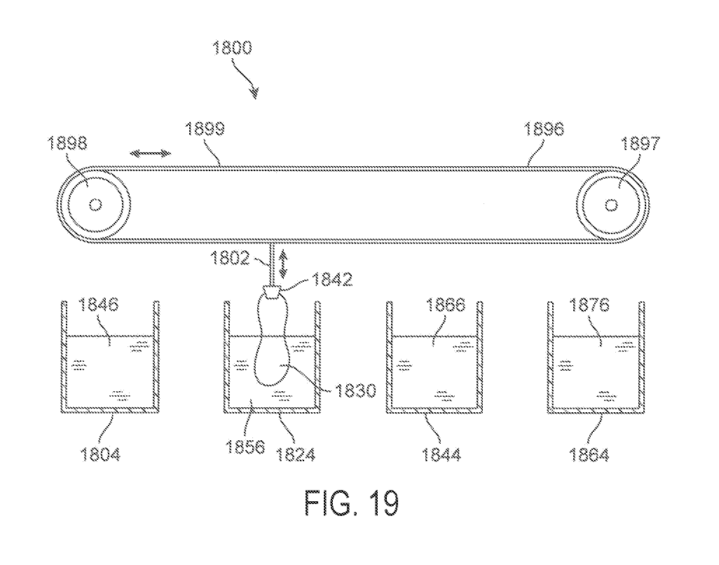

In embodiments of the disclosure, after processing in first tank 1804, actuator 1802 with retaining member 1842 and article 1830 may be moved to a position over any other tank for additional processing. In embodiments of the disclosure, actuator 1802 may be moved in the direction of the arrow to a position where article 1730 may be at least partially dipped into second tank 1824, as illustrated in FIG. 19. Second tank 1824 may contain fluid 1856, which may be a liquid colorant, a washing fluid, water, or any other processing fluid. Once positioned over tank 1824, actuator 1802 then may be activated to move retaining member 1842 in the direction of the arrow toward fluid 1856 until article 1830 is at least partially submersed in fluid 1856. After a selected dip time, actuator 1802 moves retaining member 1842 with article 1830 therein upwardly in the direction of the arrow to remove article 1830 from fluid 1856. Article 1830 then may be allowed to dry while suspended over second tank 1824 or may be moved or translated to a position over another tank. In some embodiments of the disclosure, article 1830 may be dipped a plurality of times in second tank 1824, and may be dried after any of the dips.

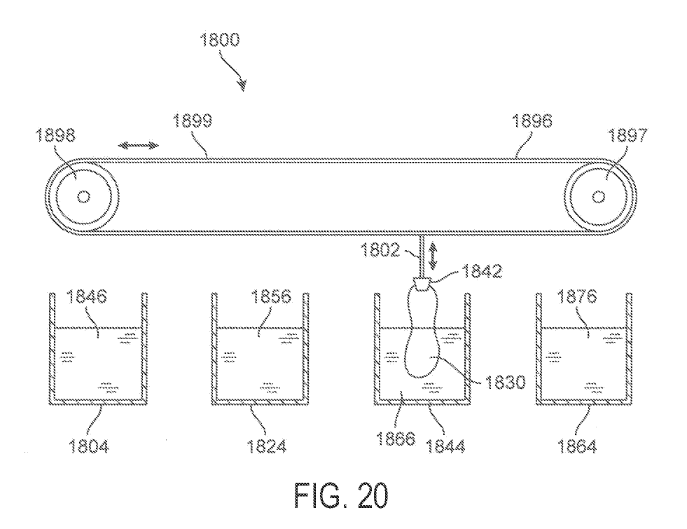

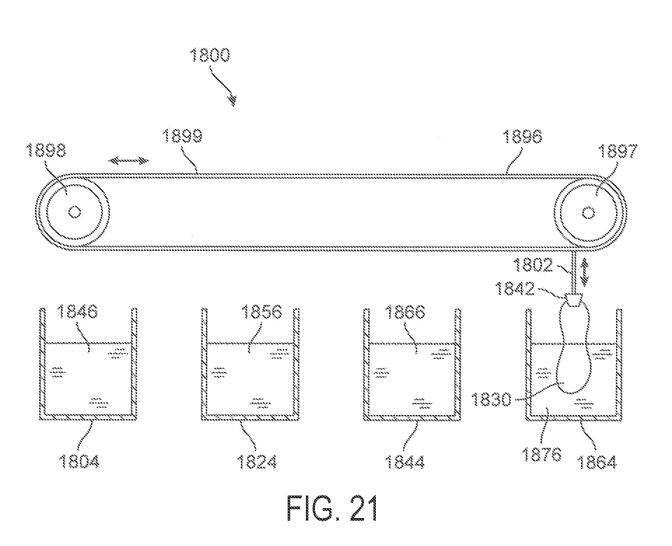

Actuator 1802 and equipment and articles thereon then may be moved to a position over any other tank. In some embodiments of the disclosure, article 1830 will be moved back to a position over first tank 1804 and further processed, as illustrated in FIG. 18. In some embodiments of the disclosure, article 1830 will be moved to a position over third tank 1844 for processing, as illustrated in FIG. 20. In some embodiments of the disclosure, article 1830 will be moved to a position over fourth tank 1864 for processing, as illustrated in FIG. 21.

FIG. 20 illustrates processing steps related to third tank 1844. Article 1830 is held in retaining member 1842 on actuator 1802 at least partly submerged in fluid 1866 in third tank 1844 for processing. Actuator 1802 has been activated to move retaining member 1842 in the direction of the arrow toward fluid 1866 until article 1830 is at least partially submersed in fluid 1866, as shown in FIG. 20. After a selected short period, actuator 1802 moves retaining member 1842 with article 1830 therein upwardly in the direction of the arrow to remove article 1830 from fluid 1866. Article 1830 then may be allowed to dry while suspended over third tank 1844 or may be moved or translated to a position over any other tank. In embodiments of the disclosure, article 1830 may be dipped into fluid 1866 and dried in a plurality of sequential cycles before being moved to a position over another tank.

FIG. 21 illustrates processing steps related to fourth tank 1864. Article 1830 is held in retaining member 1842 on actuator 1802 at least partly submerged in fluid 1876 in fourth tank 1864 for processing. Actuator 1802 then may be activated to move retaining member 1842 in the direction of the arrow toward fluid 1876, as illustrated until article 1830 is at least partially submersed in fluid 1876, as illustrated in FIG. 21. After a selected short period, actuator 1802 moves retaining member 1842 with article 1830 therein upwardly in the direction of the arrow to remove article 1830 from fluid 1876. Article 1830 then may be allowed to dry while suspended over fourth tank 1864 or may be moved or translated to a position over another tank. In embodiments of the disclosure, article 1830 may be dipped into fluid 1846 and dried in a plurality of sequential cycles before being moved to a position over another tank.

In embodiments of the disclosure, article 1830 thus may be moved to positions over tanks and processed by being dipped into fluid in each tank in any sequence to imbue article 1830 with color or colors having selected saturation, as illustrated in FIGS. 18-21. With the guidance provided herein, the user will be able to establish a suitable sequence.

For example, in embodiments of the disclosure, third tank 1844 may contain fluid 1866, which may be a liquid colorant, a washing fluid, water, or any other liquid. If fluid 1866 is a liquid colorant, liquid colorant 1866 may be the same as or different from liquid colorant 1846, for example. Similarly, fourth tank 1864 may contain fluid 1876, which may be a liquid colorant, a washing fluid, water, or any other liquid. If fluid 1876 is a liquid colorant, liquid colorant 1876 may be the same as or different from liquid colorant 1866 and may be the same as or different from liquid colorant 1846.

In some embodiments of the disclosure, the article may first be dipped only to the shallowest depth, or shortest distance, of a color segment contemplated. Then, after drying, subsequent dips may be deeper into the liquid colorant. Thus, the area of least saturation is colored last in these embodiments of the disclosure.

An example of a part of an article of footwear that may be dyed in accordance with embodiments of the disclosure herein is a light diffuser. Such a diffuser may be placed in a sole structure of the article of footwear in a manner so that a light (e.g., one or more light emitting diodes (LEDs) or an array of LEDs) placed in the diffuser may be seen on the article of footwear. Thus, the diffuser may be embedded or otherwise mounted on or in a sole structure, for example. It may be convenient to embed the diffused in, for example, the heel portion of the sole structure, or in a heel counter.

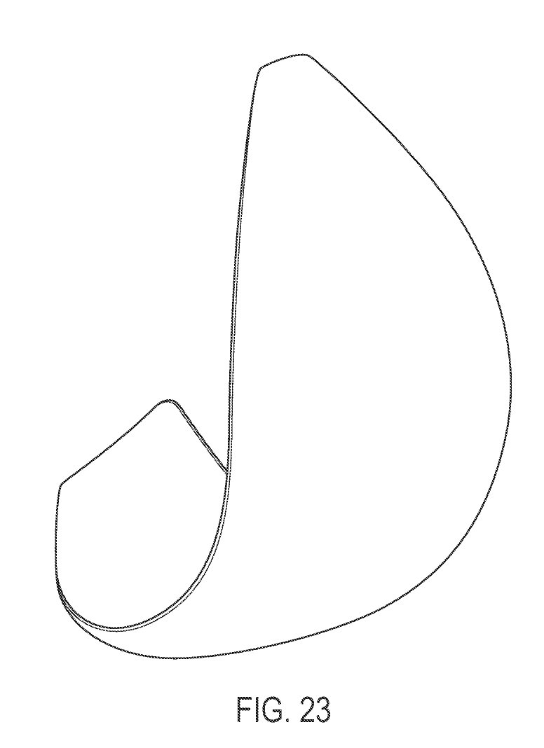

FIGS. 22-23 illustrate the interior and exterior of an exemplary heel counter including light diffuser D. Diffuser D allows light from a light source contained within the heel counter to be visible to the outside of the heel counter. Thus, the heel counter comprises a material that contains a translucent, transparent, or similar diffuser within a heel counter that essentially blocks transmission of light at every position on the counter except through the light diffuser. Examples of suitable materials include materials mentioned herein as suitable for a midsole. A specific example of a suitable composition of matter is a TPU-containing injection moldable composition such as Estane® S360D commercially available from at least Lubrizol, Cleveland, USA. See

Estane® S360D is a transparent TPU. Thus, such a heel counter may include pigment or other light-blocking material for the remainder of the heel counter that is not a diffuser. For example, the counter may be dipped into very dark dye to color the light-blocking portions. In particular, the heel counter illustrated in FIGS. 22-23 may be dipped into the dye in four directions, maintaining the diffuser window parallel to but at or above the fluid level to keep it from being dyed to be opaque. The skilled practitioner can develop a dipping regime if the diffuser window includes other than straight borders.

Acid dye and other dyes identified herein may be suitable for dyeing a light diffuser containing TPU materials of construction, in accordance with embodiments of method disclosed herein. An example of a black dye composition comprises calcium cyanide, also known as black cyanide, dissolved in n-propyl alcohol at about 60° C. Then, a solution of between about 20 pct and about 50 pct n-propyl alcohol in water forms the dye. Black cyanide is present in an amount between about 0.1 g/I and about 3 g/I. A suitable dyeing process with such a dye may be to wash the heel counter for about 3 minutes and about 10 minutes at about 40° C., they dyeing by dipping the counter into the due for a cycle of dips sufficient to produce the selected black color, sometimes at a temperature between about 25° C. and about 80° C. or at a temperature between about 40° C. and about 60° C., and then rinsing with water.

In another embodiment, the diffuser may be mounted in or on a plate that may be associated with the sole structure. In other embodiments, the diffuser may form a part of the plate.

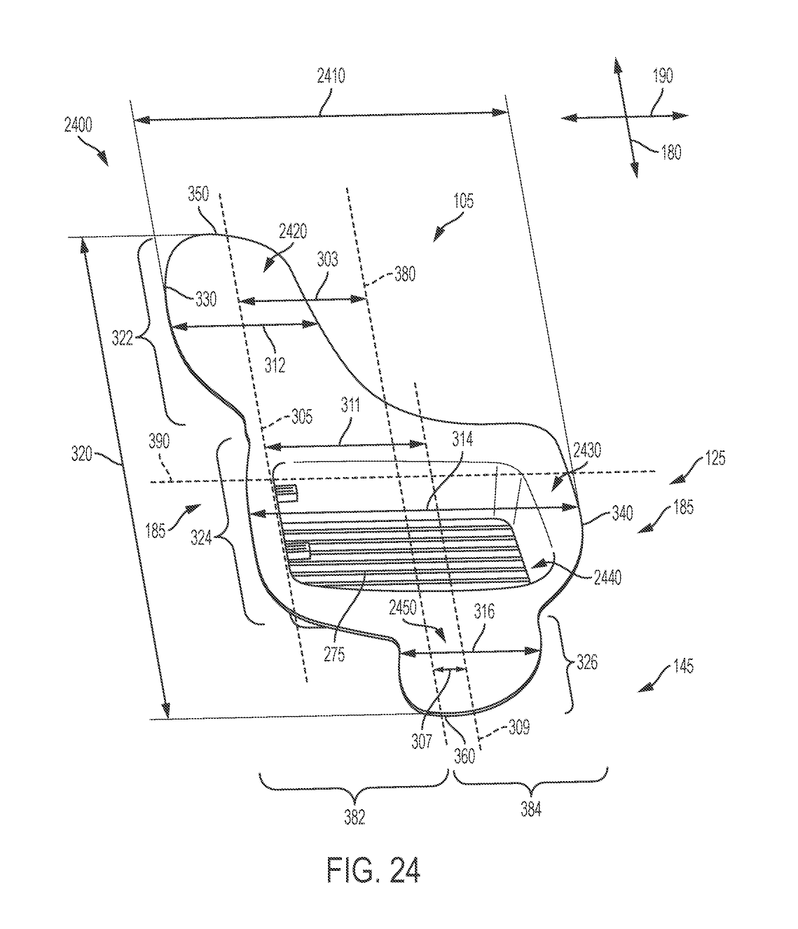

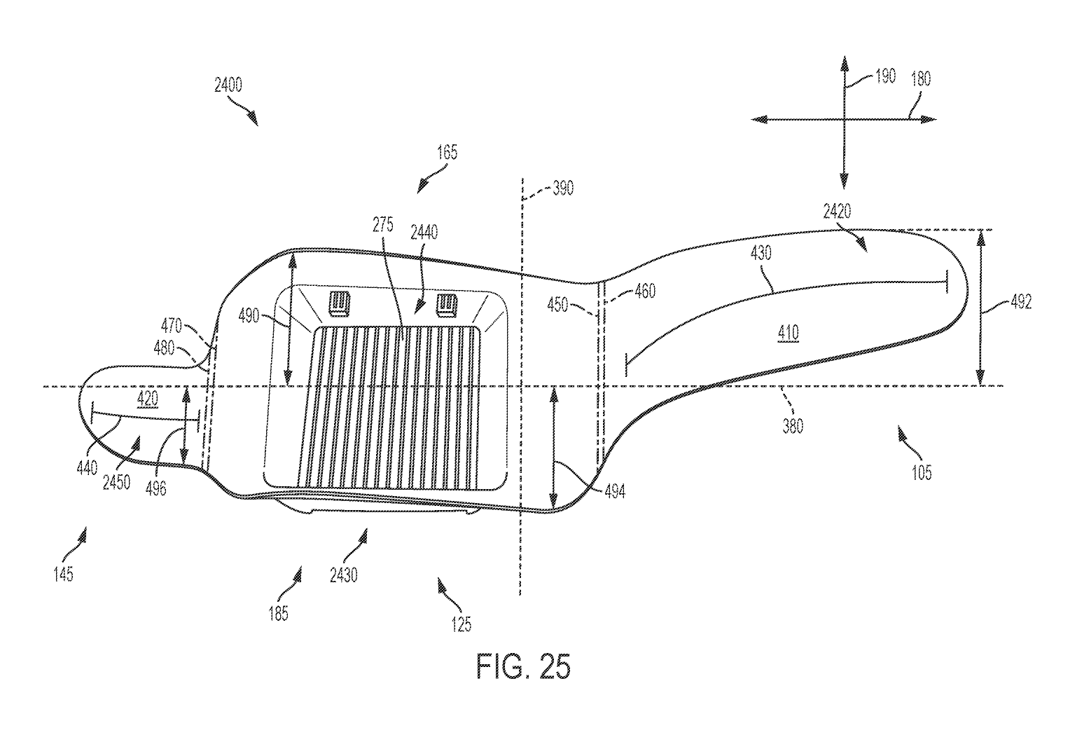

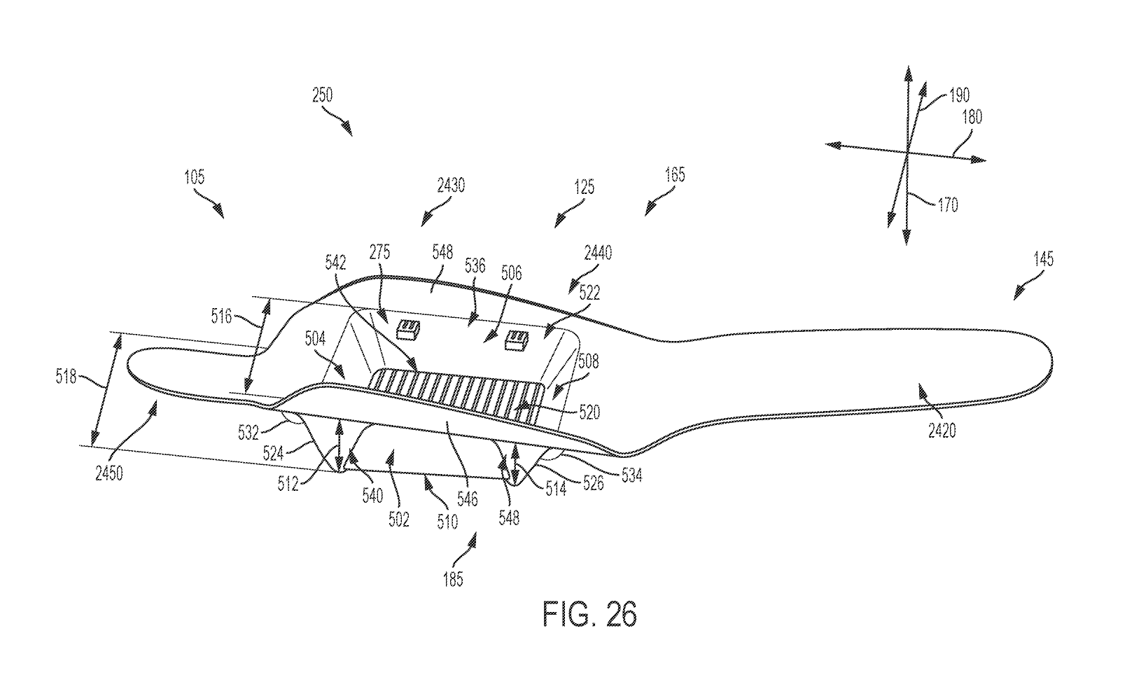

FIGS. 24-29 illustrate such an embodiment. For example, FIG. 24, FIG. 25, and FIG. 26 illustrate sole plate 2400 that may be associated with a light diffusing area. Two views are depicted of sole plate 2400 in FIGS. 24 and 25. In FIG. 24, a front isometric view of an embodiment of sole plate 2400 is illustrated, and in FIG. 25, a top-down isometric view of an embodiment of sole plate 2400 is illustrated. Sole plate 2400 can include different regions or sections in some embodiments. As shown in FIGS. 24-25, for purposes of reference, sole plate 2400 may be divided into a forward portion 2420, an intermediate portion 2430, and a rearward portion 2450. In different embodiments, the shape of sole plate 2400 can vary. In one embodiment, the shape of sole plate 2400 may resemble a generally oblong shape comprising forward portion 2420, joined to a substantially rectangular shape comprising intermediate portion 2430, which is joined to a substantially oblong shape comprising rearward portion 2450. In other embodiments, the perimeter and shape of different portions of sole plate 2400 may vary from what is depicted here, and include any regular or irregular shape.

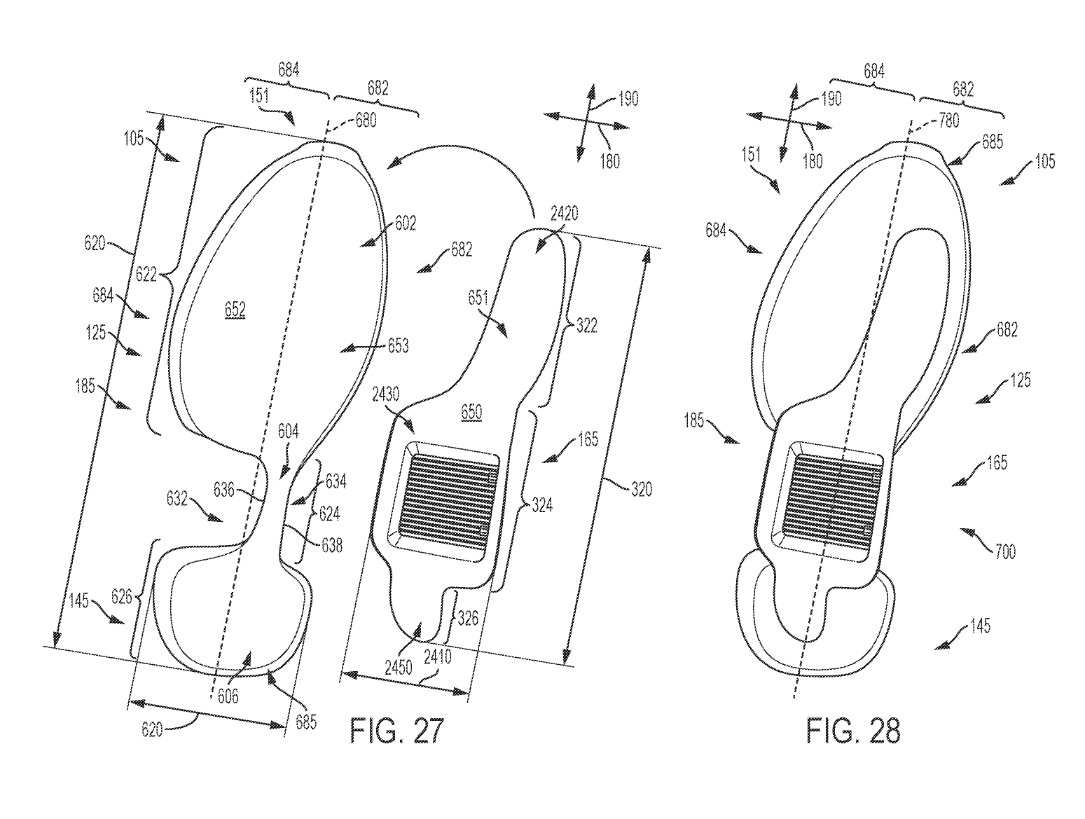

In some embodiments, portions of sole plate 2400 may comprise a substantially flat or two-dimensional material or structure. The term “two-dimensional” as used throughout this detailed description and in the claims refers to any generally flat material exhibiting a length and width that are substantially greater than a thickness of the material. Although two-dimensional materials may have smooth or generally untextured surfaces, some two-dimensional materials will exhibit textures or other surface characteristics, such as dimpling, protrusions, ribs, or various patterns, for example. In other embodiments, the geometry of sole plate 2400 could vary and could include various contours or features associated with parts of a foot, for example, the sole region of a foot. It should also be understood that in some embodiments, sole plate 2400 may be disposed along a midsole in an asymmetrical manner, as shown in FIGS. 27 and 28.

Furthermore, in some embodiments, sole plate 2400 and other components of sole structure 3020 can be formed of various material compositions. In some embodiments, sole plate 2400 can be associated with a higher stiffness or hardness than an upper of an article of footwear. In one embodiment, sole plate 2400 is at least partially formed of thermoplastic polyurethane (TPU). In other embodiments, sole plate 2400 may comprise a glass-filled nylon material. In still other embodiments, sole plate 2400 may comprise a glass-filled TPU. In particular, sole plate 2400 may be formed from a polyamide-12 nylon composition known as AESNO®, which is commercially available from numerous suppliers. Representative information about the composition is found in Attachment D. Sole plate 2400 may comprise a light-diffusive material, as will be discussed below with respect to FIG. 31.

In FIGS. 24-25, for purposes of reference, a central longitudinal axis 380 and a central lateral axis 390 are depicted superimposed over the illustration of sole plate 2400. It should be understood that central longitudinal axis 380 is arranged to generally bisect sole plate 2400 along a midline aligned with longitudinal axis 180, and central lateral axis 390 is arranged to generally bisect sole plate 2400 along a midline aligned with lateral axis 190.

Dimensional guidelines and suggestions, including relationships between the sole plate and other parts of the article of footwear, are found in additional detail in Published U.S. Appl. No. 2016/0345661 entitled A SOLE PLATE FOR AN ARTICLE OF FOOTWEAR, the entirety of which is hereby incorporated by reference. Additional details may be found in Beers, Published U.S. Appl. No. 2016/0345671, entitled A SOLE PLATE FOR AN ARTICLE OF FOOTWEAR, the entirety of which is hereby incorporated by reference.

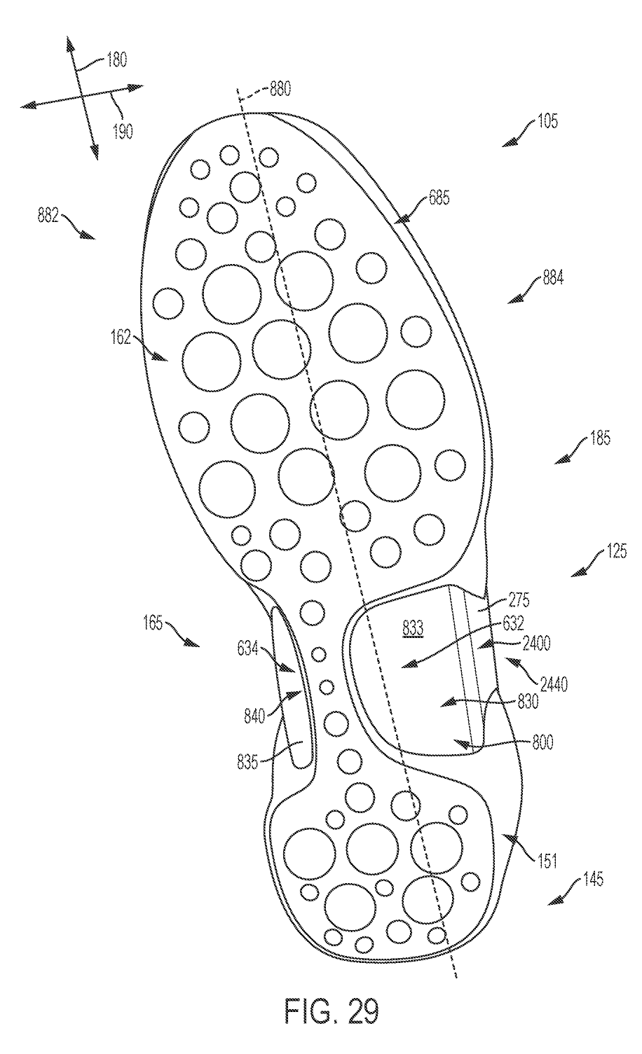

In different embodiments, sole plate 2400 may be assembled, incorporated, joined, or otherwise disposed adjacent to an additional component of article 3000. FIGS. 27-29 provide an example of the joining between two components including sole plate 2400 and midsole 151. FIG. 27 depicts a top-down view of an embodiment of sole plate 2400 and midsole 151. FIG. 28 depicts a top-down view of an embodiment of the receipt of sole plate 2400 by midsole 151, forming combined sole layers 700. In FIG. 29, a bottom isometric perspective of sole structure 3020 is illustrated, providing a view of a portion of the bottom surface of sole plate 2400.

As shown in FIG. 29, the configuration of midsole 151 can also allow portions of the underside of sole plate 2400 to remain exposed in the assembled state. For purposes of this disclosure, the underside of sole plate 2400 refers to the bottom-facing and/or outward-facing surfaces of sole plate 2400 that forms an opposing surface to inner surface side 651 (shown in FIG. 27). Furthermore, the assembled state refers to the state in which the entire sole structure (which can comprise at least sole plate 2400 and midsole 151) has been assembled and is ready for use, installation, and/or integration with an upper for an article of footwear.

In FIG. 29, an isometric bottom view of an embodiment of an assembled sole structure is shown. The sole structure includes outsole 162 joined to midsole 151, where midsole 151 is joined to or is disposed adjacent to sole plate 2400. In different embodiments, outsole 162 may include a shape and size substantially similar to that of at least a portion of midsole 151. For example, in FIG. 29, it can be seen that outsole 162 covers a large portion of midsole 151. In other embodiments, outsole 162 may comprise a different shape or size. In one embodiment, outsole 162 may cover a smaller portion of midsole 151 than depicted here. In another embodiment, outsole 162 may cover substantially all of the outer surface side (not shown) of midsole 151, where the outer surface side represents the opposing surface of inner surface side 653 (see FIGS. 27 and 28). In other embodiments, outsole 162 may be substantially larger than midsole 151.

In addition, in some embodiments, as noted earlier, sole plate 2400 may be at least partially exposed in the assembled sole structure. Referring to FIG. 8, an underside 800 of sole plate 2400 is depicted. Underside 800 can include one or more exposed regions. In FIG. 29, sole plate 2400 includes two exposed regions, here referred to as a third region 830 and a fourth region 840. In some embodiments, third region 830 can include both a portion of base portion 510 and a portion of first sidewall 502 (identified in FIG. 26). Similarly, in some embodiments, fourth region 840 can include both a portion of base portion 510 and a portion of third sidewall 506 (shown in FIG. 26).

In different embodiments, third region 830 can correspond with first region 632 of midsole 151, and fourth region 840 can correspond with second region 634 of midsole 151. In other words, third region 830 may be defined by the boundary that also surrounds and defines first region 632, and fourth region 840 may be defined by the boundary that also surrounds and defines second region 634. Furthermore, in some embodiments, third region 830 may encompass or comprise a larger area than fourth region 840. For example, in FIG. 29, third region 830 has a third area 833 and fourth region 840 has a fourth area 835, where third area 833 is greater than fourth area 835. In other words, third region 830 and fourth region 840 may be asymmetric with respect to their degree of exposure. Thus, base portion 510 is asymmetrically exposed, where medial side 165 of base portion 510 is less exposed or is smaller in size than lateral side 185 of base portion 510. However, it should be understood that in other embodiments, third area 833 may be substantially similar to or less than fourth area 835. For example, medial side 165 of base portion 510 can be more exposed or be larger in size than lateral side 185 of base portion 510 in some embodiments.

Thus, the arrangement of exposed regions of sole plate 2400 may vary. For example, fourth region 840 is arranged such that it is disposed along medial side 165 of the assembled sole structure. In addition, third region 830 is arranged such that it is substantially disposed toward lateral side 185 of the assembled sole structure, though a smaller proportion of third region 830 can also extend into medial side 165. In other words, if it is understood that third central longitudinal axis 880 represents a longitudinal midline of the assembled sole structure, fourth region 840 can be disposed along a first side 882 and third region 830 can be disposed primarily along a second side 884.

In other embodiments, it should be understood that additional materials or components may be included or inserted into sole structure 3020. In one embodiment, to enhance the impact strength of sole plate 2400, there may be a portion of rubber or dampening material adhered to one surface or portion of sole plate 2400, for example. In other embodiments, insulating material or other filler or cushioning material may be deposited around component 900 during installation of component 900.

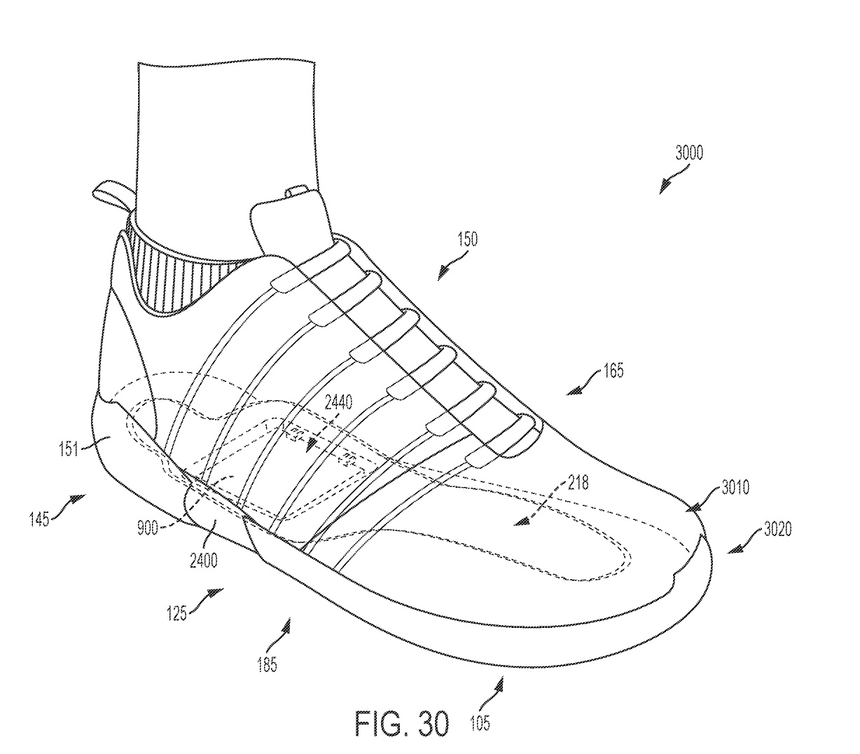

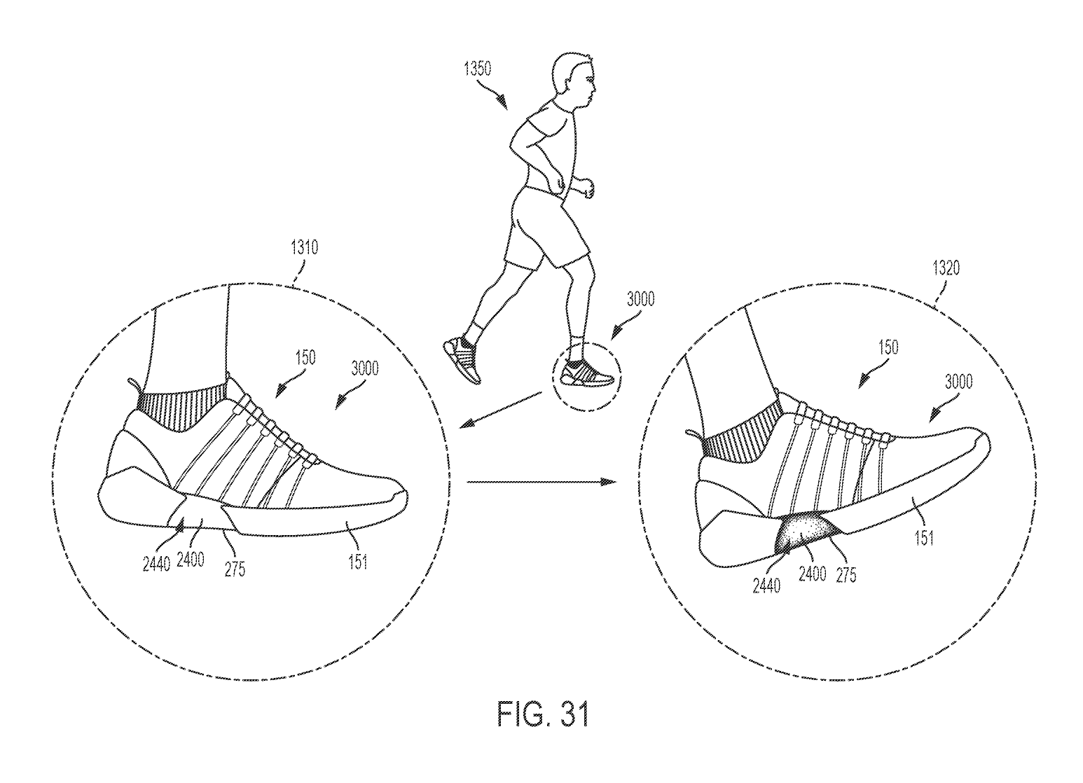

Referring now to FIG. 30, article 3000 is illustrated with component 900 installed. In FIG. 30, upper 3010 and sole structure 3020 are depicted in solid line, while component 900 and sole plate 2400 are depicted in dotted lines, to provide a view of interior void 218. It can be seen that component 900 is disposed in compartment 2440 within sole plate 2400.

In other embodiments, any component could be disposed in any other portions of an article, including the upper and/or sole structure. In some cases, some components could be disposed in one portion of an article and other components could be disposed in another, different, portion. In another embodiment, for example, component 900 comprising the housing unit with a motorized tensioning device could be disposed near heel region 145 of sole plate 2400 in article 3000. The location of one or more components may be selected according to various factors including, but not limited to: size constraints, manufacturing constraints, aesthetic preferences, optimal design and functional placement, ease of removability or accessibility relative to other portions of article 3000, as well as possibly other factors.

Once components have been installed in article 3000, various systems may be operated or used by a wearer. In one embodiment, when the system associated with article 3000 is activated or utilized, a signal may be transmitted to activate an LED unit that can be disposed in the component. During use by a wearer 1350 of article 3000, LED lights associated with the component can turn on and off.

In different embodiments, some regions of article 3000 may be configured for providing optimal use of various components. In one example, sole plate 2400—specifically the region of sole plate 2400 associated with compartment 2440 (particularly exposed third region 830 and/or fourth region 840 as shown in FIG. 29) may include light-diffusive, light-transmissive, translucent, and/or transparent materials. Such materials can facilitate the transmission of light from an LED (or other light source) that has been incorporated into cavity 275 or other portions of article 3000 during or after manufacture of article 3000.

Referring to FIG. 31, the material comprising cavity 275 may be formed of a light-diffusive material, for example. Thus, component 900 comprising an LED unit may emit light that can be visible to the wearer or others via the diffuse material of sole plate 2400. In some embodiments, an enhanced aesthetic design may be produced by the use of various diffusive materials with an LED unit, providing the wearer with a light diffuser effect. For example, in FIG. 31, in a first view 1310, article 3000 is shown in an “LED off” state. However, as shown in a second view 1320, article 3000 may transition to an “LED on” state, where one or more lights located within cavity 275 of sole plate 2400 may turn on. In one embodiment, light can be emitted through the material comprising cavity 275 in the “LED on” state. This is illustrated in second view 1320 of FIG. 31, where light is being diffused through third region 830 (labeled in FIG. 29) of sole plate 2400.

Sole plates including a light diffusing area and heal counters including a light diffusing area may be dyed, as disclosed herein, by dipping at least a portion of the plate or of the counter into dye for a series of dips. The temperature of the dye may be maintained between about 25° C. and about 80° C. or between about 40° C. and about 60° C. As set forth in the attached documents, the short-time, multi dip method provides desired color to the dyed article more quickly than would a single dip of relatively long duration.

In some embodiments, the light diffuser of the various embodiments described herein, including light-diffusive, light-transmissive, translucent, and/or transparent materials, has a low absorption of light that impinges thereon, even though the light diffuser has been colored according to the methods described herein and the light diffuser may be highly colored. For example, the light diffuser of the various embodiments described herein has less than about 70% total absorption of the light (e.g., light of a wavelength of from about 360 nm to about 1600 nm) that impinges thereon (e.g., less than about 60%, less than about 50%, less than about 40%, less than about 30%, less than about 20%, less than about 15%, less than about 10%, less than about 5%, less than about 1%; about 1% to about 70%; about 1% to about 50%; about 1% to about 25%; about 5% to about 25%;about 5% to about 15%; about 10% to about 25%; about 1% to about 15%; or about 1% to about 5% total absorption of the light that impinges thereon).

The light diffuser of the various embodiments described herein can have a smooth surface or a roughened surface or a combination of a smooth surface and a roughened surface (e.g., a generally roughened surface and a logo and/or a word stamped thereon, wherein the logo and/or word has a smooth surface).

The short-time, multiple-dip embodiment also protects an article from overheating, which could destroy the article by warping, partial melting, distortion, or other damage to the article. These adverse effects may be more prevalent on thin articles or thin components. Similarly, excessive heat may embrittle a diffuser-containing article. Thus, the short-time, multiple dip method embodiment is useful in maintaining product integrity while improving product appearance.

The density of articles dyed in accordance with embodiments of a short-time, multi-dip technique may be less than the density of the dyeing liquid. Articles to be dyed also may not be sufficiently rigid to maintain their shape when dipped into dye liquid. Therefore, it may be necessary to utilize a holding appliance that grips or otherwise restrains the article to be dyed in more than one location.

FIG. 32-35 illustrate apparatus for dipping a sole plate. The skilled practitioner recognizes that a similar appliance may be used for dyeing a heel counter.

As seen in FIG. 32, container 206 may be arranged in an inverted position with respect to tank 204. In particular, second end portion 213, which includes bottom opening 212, is disposed closer to tank 204 than first end portion 211. As described in further detail below, this arrangement allows liquid coloring agent 246 to partially fill interior 214 as container 206 is lowered into tank 204.

In FIG. 32, an embodiment of the assembly 202 is depicted before introducing container 206 into tank 204. Article 230, in an uncolored/un-dyed state, is shown disposed inside inverted container 206. In this particular configuration, article 230 is retained at front foot portion 232 and at heel portion 234.

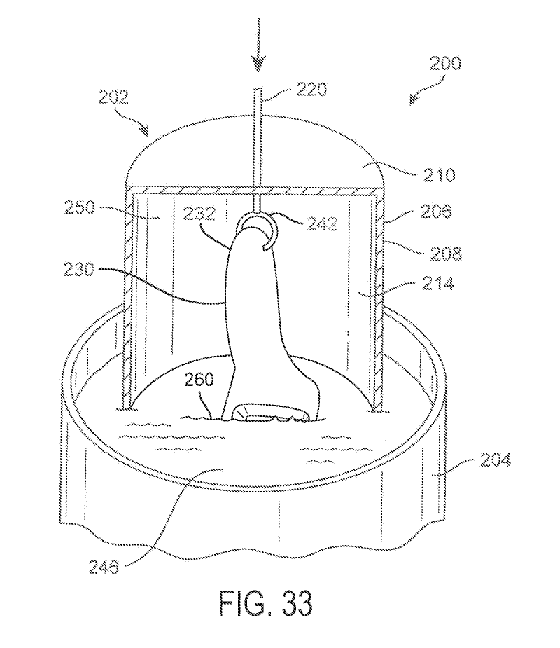

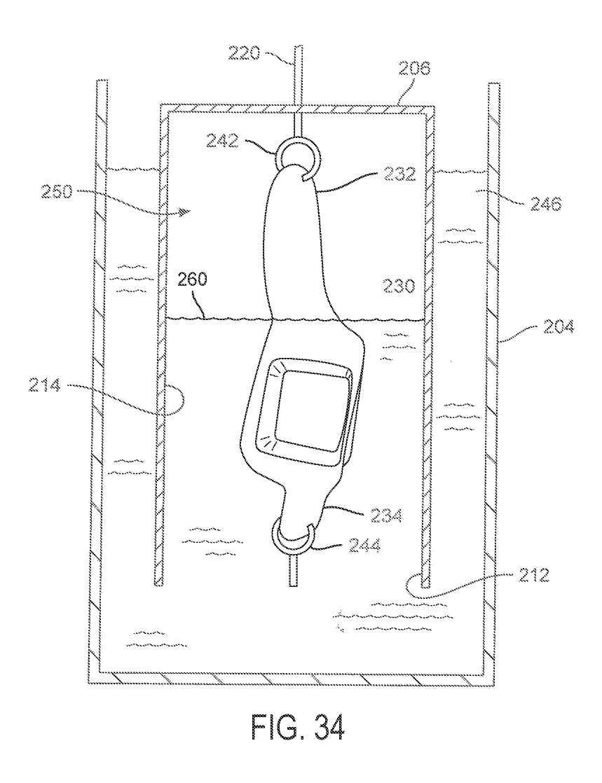

FIGS. 33 and 34 show an embodiment of assembly 202 in a process of lowering container 206 into tank 204. As discussed above, tank 204 may be filled with liquid coloring agent 246. In some embodiments, liquid coloring agent 246 may comprise a liquid dye. In some embodiments, liquid coloring agent 246 may be a liquid dye with color 248.

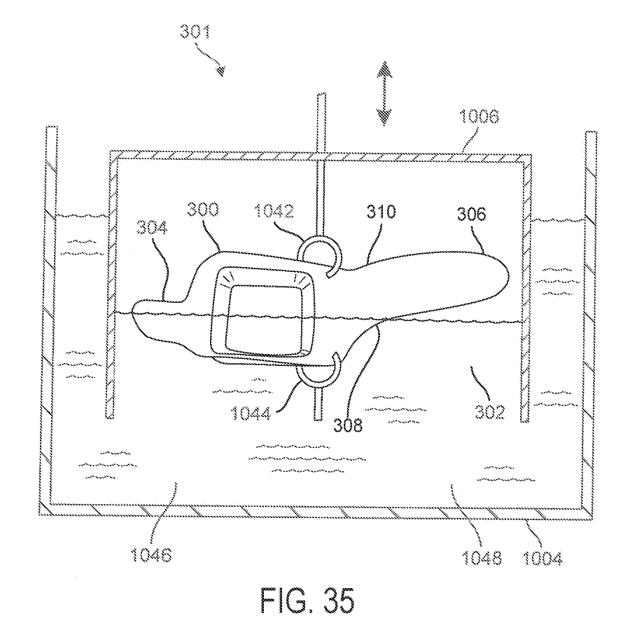

Referring to FIG. 35, actuator 220 lowers container 206 into tank 204 as indicated by a downward pointing arrow. As container 206 is lowered, a portion of container 206 is introduced into tank 204. Bottom opening 212 of container 206 allows for liquid coloring agent 246 to enter interior 214 of container 206.

Air pocket 250 is created as container 206 is lowered into tank 204. In particular, as bottom opening 212 of container 206 comes into contact with liquid coloring agent 246, air within interior 214 of container 206 becomes trapped (or sealed) within container 206. Specifically, the air within interior 214 is captured within the volume bounded by top wall 210, side wall 208, and the surface of liquid coloring agent 246.

In the configuration of FIG. 33, article 230 is shown as partially dipped into liquid coloring agent 246. Heel portion 234 (not visible) is submersed in the liquid coloring agent 246. However, front foot portion 232 in disposed above the surface of liquid coloring agent 246 and within air pocket 250.

In some embodiments, article 3000 may be buoyant. For example, in embodiments where article 230 is a bladder member or airbag, article 230 may be especially buoyant and resist being submerged in a liquid. Therefore, upper retaining member 242 and lower retaining member 244 may prevent article 230 from floating while being dipped into liquid coloring agent 246. This arrangement allows open bottom 212 of container 206 to be at least partially submersed below a liquid level in tank 204.

As seen in FIG. 34, the liquid level 260 (also shown in FIG. 33) of liquid coloring agent 246 within the container 206 may vary with the volume of air pocket 250. The volume of air pocket 250 may vary with the depth of submersion of container 206 within tank 204. In particular, as container 206 is further submerged, the volume of air pocket 250 may be further compressed. In some embodiments, the volume of air pocket 250 may be controlled independently from the submersion depth by using other provisions to increase the pressure within air pocket 250 and thereby maintain an approximately constant volume, or may otherwise change the volume of air pocket 250.

With container 206 submerged to a predetermined level within tank 204, liquid level 260 defines the transition between a first portion of article 230 that is outside of liquid coloring agent 246 and a second portion of article 230 submerged within liquid coloring agent 246. Here, the first portion is front foot portion 232 while the second portion is heel portion 234. In other embodiments, however, the first portion and the second portion could be any other portions. By holding container 206 at this depth for a predetermined short period, heel portion 234 of article 230 can be colored by liquid coloring agent 246. In this case, container 206 is shown as mostly, but not entirely submerged within liquid coloring agent 246. In other embodiments, container 206 could be completely submerged within liquid coloring agent 246.

FIG. 35 depicts an embodiment having an alternative retaining position of article 300. In the example shown, article 300, which includes a front foot portion 302 and a heel portion 304, is positioned horizontally, rather than vertically as in the previous embodiment. Top side 306 of article 300 is viewed in the plane of the drawing. In this configuration, a lateral peripheral edge portion 308 of article 300 is secured in container 1006 by upper retaining member 1042. Medial peripheral edge portion 310 of article 300 is secured in container 1006 by lower retaining member 244.

Embodiments of the disclosure relating to the method are essentially the same for any application of any color to an article. Assembly 301 is shown being lowered into tank 1004 filled with liquid coloring agent 1046 of color 1048 for example. The process for coloring article 300 is repeated according to the previous exemplary embodiment discussed above and shown in FIGS. 24 through 29. However, it will be understood that article 300 in the present embodiment is inverted in the container 1006 in a manner (not shown) such that when inverted medial peripheral edge portion 310 is secured in container by upper retaining member 1042. Further, lateral side peripheral edge portion 308 of article 300 is secured in container by lower retaining member 1044 in the inverted position. Container 1006 is then transferred and submerged into another tank for applying another color.

These embodiments show some possible orientations for an article with respect to the surface of a liquid coloring agent. In particular, the embodiments depict configurations where the article may be vertical to the surface (e.g., FIG. 34) or horizontal (e.g., FIG. 35). In other embodiments, the position of the article can be angled relative to the liquid coloring agent surface, rather than being vertically or horizontally oriented.

Liquid colorant material sometimes comprises colorant and a solvent for the colorant. After an article has been dipped into the liquid colorant and removed therefrom, the article is dried and the solvent is evaporated or otherwise removed. Other compounds, such as mordants, optical enhancing agents, viscosity agents, and other additive compounds may be present, sometimes in minor amounts. During drying, excess liquid colorant may be allowed to drip back into the liquid colorant in the container, and the solvent and other volatile materials in the liquid colorant may evaporate to yield a dry colored article.

In embodiments of the disclosure, a volatile agent, i.e., a compound having vapor pressure higher than the vapor pressure of the liquid colorant, may be included in the liquid colorant to shorten drying time. In embodiments of the disclosure, drying may be accelerated by blowing gas, which may be at any temperature but sometimes is at least ambient temperature, on or in the vicinity of the article to be dried. In such embodiments, the gas may be any gas that does not react adversely with colorant. In some embodiments, the gas is nitrogen or air, but sometimes air.

In some embodiments of the disclosure, the liquid colorant in the container is maintained at an elevated temperature, i.e., above ambient temperature. In such embodiments of the disclosure, a dipped article may be dried quickly, and then may be dipped again. The article may be dipped in the same liquid colorant, or maybe dipped in another liquid colorant. In embodiments of the disclosure, any portion of the article maybe dipped into another liquid colorant. In embodiments of the disclosure, a portion of the article that has already been colored may be dipped in the same color or in a different color. In another embodiment of the disclosure, the second or additional colors may be applied to areas of the article that have not been colored previously. These embodiments of the disclosure create a colored article having two or more colors thereon. Such an article is shown in FIGS. 1, 2, 8, and 9, for example.

For example, FIG. 9 depicts article 230 having heel portion 234 having first color portion 268, front foot portion 234 having a first color 248, and transition portion 281 having a third color that is a blend of the first color and the second color. The transition portion provides a smooth color transition to provide a visually pleasing transition between first color and a second color.

In embodiments of the disclosure, heel portion 234 of article 230 is dipped into liquid colorant 246 up to first color line 262 to impart first color 248 to the heel portion, as illustrated in FIG. 6. The article then is dried and inverted, as illustrated in FIG. 7, and is shown in FIG. 8 with heel portion 234 above front foot portion 232. FIG. 8 shows front foot portion 232 dipped into second liquid colorant 266 past color line 262 to the depth of liquid level 260. This dip imparts color 268 to first front foot portion 232 of article 230, up to second color line 272. Thus, a transition zone 281 having a color that is a blend of first color 248 and second color 268, as shown in FIG. 9. In such embodiments of the disclosure, three colors are present on the article, specifically, first color 248, second color 268, and a blend thereof.

In such embodiments of this disclosure, only one dip/dry cycle in each color was used. However, in other embodiments of the disclosure, multiple dip/dry cycles may be carried out with each liquid colorant, or with any liquid colorant. In embodiments of the disclosure using more than one color, the number of dip/dry cycles in each color may be the same. In other embodiments of the disclosure using more than one color, the number of dip/dry cycles in each color may be different. With the guidance provided herein, the user will be able to obtain the desired saturation level of each color in a multicolor system and any overlapping portions thereof.

In some embodiments of the disclosure, a color or colors may be applied to an article in separate regions that touch but do not overlap. In other embodiments of the disclosure, a color colors may be applied to an article in separate regions that do not touch. In such embodiments of the disclosure, uncolored regions will be visible between the colored regions.

### EXAMPLES

The following examples are intended to illustrate the subject matter of the disclosure, not to limit it in any way.

### Example 1

An article that may be associated with a sole system for footwear is dyed to have a gradient of color from a toe portion to a heel portion. The entire article is dipped, heel portion first, in suitable colored dye for 30 seconds, then removed and dried. The dried article is dipped in the same dye to a depth of 99 percent of its length for 30 seconds, removed, and dried. The dried article is dipped in the same dye to a depth of 98 percent of its length for 30 seconds, removed, and dried. This dip/dry cycle wherein the dip depth is reduced 1 percent in each successive cycle is repeated, with the last cycle dyeing 1 percent of the length of the article.

The resultant article presents a pleasing appearance of a color gradient having increasing saturation from the toe portion, which is only lightly saturated in color, to the heel portion, which is richly saturated.

### Example 2

An article that may be associated with a sole system for footwear is dyed to have a gradient of red color from a heel portion to about 60 percent of the length of the article, approximately in a midfoot region. The same sole system is dyed to have a gradient of yellow color from a toe portion to about 60 percent of the length of the article, ending similarly approximately in the midfoot region. The article is colored using a dip/dry cycle of 30 seconds each step, repeated 20 times. The resultant article is pleasingly colored in 3 discrete bands. From the toe portion to about 40 percent of the length of the article, the article is yellow. Twenty percent of the length of the article in the midfoot portion is orange, and the remaining 40 percent of the article, in the heel portion, is red.

### Example 3

An article is dyed to have a gradient of green color across the entirety of the article. The relationship between the saturation and the number of dips is not linear for this combination of substrate and dye. Rather, saturation is related to number of dips as set forth in Table 2, as follows:

TABLE 2

| Color segment | Number of dips | % Saturation | C* at same hue |
|---|---|---|---|
| 1 | 1 | 3 | 1.5 |
| 2 | 2 | 6 | 3.0 |
| 3 | 3 | 10 | 5.0 |
| 4 | 4 | 15 | 7.5 |
| 5 | 5 | 21 | 10.5 |
| 6 | 6 | 28 | 14.0 |
| 7 | 7 | 38 | 19.0 |
| 8 | 8 | 51 | 25.5 |
| 9 | 9 | 68 | 34.0 |
| 10 | 10 | 100 | 50.0 |

The article exhibits a pleasing gradient of green color that starts pale at one end, is less than 50 percent saturated at the midpoint, and increases rapidly to full saturation across the remainder of the article.

### Example 4

An article is dyed to have a gradient of purple color across the entirety of the article. The relationship between the saturation and the number of dips is not linear for this combination of substrate and dye. Rather, saturation is related to number of dips as set forth in Table 3, as follows:

TABLE 3

| Color segment | Number of dips | % Saturation |
|---|---|---|
| 1 | 1 | 22 |
| 2 | 2 | 40 |
| 3 | 3 | 52 |
| 4 | 4 | 62 |
| 5 | 5 | 72 |
| 6 | 6 | 80 |
| 7 | 7 | 88 |
| 8 | 8 | 94 |
| 9 | 9 | 97 |
| 10 | 10 | 100 |

The article exhibits a pleasing gradient of purple color that starts pale at one end and increases rapidly to a saturation greater than 50 percent at the midpoint, and then increases gradually to full saturation across the remainder of the article.

### Examples 5, 6, and 7

Thermoplastic polyurethane parts of an article of footwear were dyed in various schemes using dyes from Huntsman Corp., The Woodlands, Tex., USA, and Bezema AG, Monlingen, Switzerland. Tetrabutylammonium salts were used, and n-propanol was the organic solvent. Deionized water was used throughout.

Dye solution was prepared by adding a pre-determined amount of dye to a mixture of between about 70 vol percent and about 85 vol percent water and between about 30 vol percent to about 15 vol percent n-propanol. The dye was dissolved with agitation as the solution was heated to between about 45° C. and about 50° C. After the dye was dissolved, the ammonium salt was added, as either a solid or a concentrated aqueous solution.

The parts were washed in a mixture of 60 vol percent n-propanol and 40 vol percent water at 50° C. for 2.5 minutes. The washed pieces then were dyed on three different machines in accordance with the following protocol:

| | Dye | Dye | Dye | Dye | Rinse |
|---|---|---|---|---|---|
| | Tank #1 | Tank #2 | Tank #3 | Tank #4 | Tank |
| Delay before cycle starts | 0.5 sec | 0.5 sec | 0.5 sec | 0.5 sec | 0.5 sec |
| Time for part to reach | 0.3 sec | 0.3 sec | 0.3 sec | 0.3 sec | 0.3 sec |
| liquid | | | | | |
| Dip distance, mm | 2 | 4 | 5 | 8 | 10 |
| Number of dips | 6 | 6 | 6 | 4 | 3 |
| Dwell (dip) time | 5 sec | 5 sec | 5 sec | 5 sec | 5 sec |
| Part rotated before dips? | No | No | No | 30° | 30° |
| Time before returned to | — | — | — | 3 sec | 3 sec |
| original position | | | | | |

The results in Examples 5, 6, and 7 were obtained. As can be seen, each part was subjected to 22 dips in dye with 5 second dip times.

### Example 5

### Single Axis Dipping Machine

A single axis dipping machine was used to color the part blue. The following table indicates the results of the dip:

| | L* | a* | b* | C* | h |
|---|---|---|---|---|---|
| Standard | 47.31 | −12.91 | −25.5 | 28.59 | 243.15 |
| | DL* | Da* | Db* | DC* | DH |
| Dipped part | 0.24 | −0.92 | −0.51 | 0.88 | −0.58 |

The DE(CMC) is 0.63, so the part is considered to pass the color comparison test.

### Example 6

### Multi-Axis Dipping Machine

A multi-axis dipping machine was used to color 2 parts in each of 7 colors in individual runs. The following table indicates the results of the dips.

| | DL* | Da* | Db* | DC* | DH* | DE(CMC) |
|---|---|---|---|---|---|---|
| Bright | 0.22 | −2.22 | −0.20 | −2.21 | 0.27 | 0.85 |
| Red #1 | | | | | | |
| Bright | 0.41 | −1.40 | 0.19 | −1.33 | 0.49 | 0.6 |
| Red #2 | | | | | | |
| Green #1 | −1.19 | −0.48 | 0.89 | 0.75 | −0.67 | 0.82 |
| Green #2 | −0.49 | 0.89 | 0.46 | −0.68 | −0.74 | 0.7 |
| Fuchsia #1 | −0.48 | −1.19 | −0.19 | −1.20 | −0.06 | 0.57 |
| Fuchsia #2 | −0.50 | −1.06 | −0.53 | −1.11 | −0.41 | 0.6 |
| Red #1 | 0.60 | 0.33 | 1.24 | 0.79 | 1.02 | 0.93 |
| Red #2 | 0.52 | 0.01 | 1.14 | 0.45 | 1.04 | 0.88 |
| Bright | −0.23 | 0.92 | 0.78 | −0.39 | −1.14 | 0.95 |
| Green #1 | | | | | | |
| Bright | −1.32 | −0.59 | 0.97 | 1.00 | −0.55 | 0.92 |
| Green #2 | | | | | | |
| Jade #1 | −1.36 | −1.00 | 0.25 | 0.98 | −0.33 | 0.85 |
| Jade #2 | −1.48 | −1.25 | 0.04 | 1.24 | −0.16 | 0.97 |
| Metallic | −0.03 | −0.26 | 0.36 | 0.44 | −0.09 | 0.59 |
| Silver #1 | | | | | | |
| Metallic | 0.38 | −0.43 | 0.50 | 0.66 | −0.09 | 0.88 |
| Silver #2 | | | | | | |

The DC(CMC) values in bold above are acceptable but may be considered marginal. As can be seen, each of the comparisons was acceptable.

### Example 7

### Modified Submersion Dipping Machine

This machine was used to color a plurality of parts orange. The average difference values for the various factors were as follows:

| | DL* | Da* | Db* | DC* | DH* | DE(CMC) |
|---|---|---|---|---|---|---|
| Orange-avg. | −0.29 | −1.4 | −0.25 | −1.1 | 0.9 | 0.87 |

As can be seen, this comparison is acceptable.

While various embodiments of the invention have been described, the description is intended to be exemplary, rather than limiting and it will be apparent to those of ordinary skill in the art that many more embodiments and implementations are possible that are within the scope of the invention. For example, the disclosure is directed in detail to footwear, but the method described herein can be used on any article. Other articles that can be suitably colored in accordance with embodiments of the disclosure include key fobs, for example. Accordingly, the invention is not to be restricted except in light of the attached claims and their equivalents. Also, various modifications and changes may be made within the scope of the attached claims.

What is claimed is:

1. A method for coloring an article including a light diffuser, said method comprising:
(a) dipping at least a first portion of the article into a first liquid colorant having a first color to a first predetermined depth for a first short period less than the 100 percent single dip saturation time of the color;
(b) removing the article from the liquid colorant; and
(c) drying the article.

2. The method of claim 1, further comprising:
(d) dipping at least a second portion of the dried article into a second liquid colorant having a second color to a second predetermined depth for a second short period less than the 100 percent single dip saturation time of the second color,
(e) removing the article from the liquid colorant; and
(f) drying the article.

3. The method of claim 2, further comprising repeating the dyeing and drying steps until the article is imbued with the selected colors and saturations.

4. The method of claim 2, wherein the article is a part of an article of footwear.

5. The method of claim 2 wherein the article is a midsole of an article of footwear.

6. The method of claim 2 wherein the first portion at least partially overlaps with the second portion to form a third color.

7. The method of claim 1, wherein the light diffuser forms part of a heel counter or of a sole plate of an article of footwear.

8. The method of claim 1, wherein the light diffuser the diffuser is embedded or otherwise mounted on or in a sole structure of an article of footwear.

9. A method for dyeing an article including a light diffuser to a predetermined saturation, wherein the predetermined saturation is normally achieved by placing the article in a liquid colorant for a 100 percent single dip saturation time and then drying the article for a 100 percent drying time, the method comprising the steps of:
(a) placing the article in the liquid colorant for a first short period, the first short period being less than the 100 percent single dip saturation time;
(b) removing the article from the liquid colorant for a first short drying period;
(c) placing the article back into the liquid colorant for a second short period, the second short period being less than the 100 percent single dip saturation time; and
(b) removing the article from the liquid colorant for a second short drying period;
wherein the first short period plus the first short drying period plus the second short period plus the second short drying period, when added together, are cumulatively less than the 100 percent single dip saturation time and 100 percent single dip saturation drying time added together.

10. The method of claim 9, wherein the first short period and the second short period are independently between about 5 seconds and about 120 seconds.

11. The method of claim 9, wherein the first short period and the second short period are independently between about 10 seconds and about 60 seconds.

12. The method of claim 9, wherein the first short period and the second short period are independently less than about 5 percent of the 100 percent single dip saturation time.

13. The method of claim 9, further comprising dipping the article into the liquid colorant less than about 40 times with short periods less than about 2 percent of the 100 percent single dip saturation time.

14. The method of claim 9, further comprising dipping the article into the liquid colorant less than about 25 times with short periods less than about 3 percent of the 100 percent single dip saturation time.

15. The method of claim 9, further comprising dipping the article into the liquid colorant less than about 10 times with short periods less than about 5 percent of the 100 percent single dip saturation time.

16. The method of claim 9, wherein the light diffuser forms part of a heel counter or of a sole plate of an article of footwear.

17. The method of claim 9, wherein the light diffuser the diffuser is embedded or otherwise mounted on or in a sole structure of an article of footwear.

18. A method for dyeing an article including a light diffuser to have a first area having a first predetermined saturation of a first color and a second area having a second predetermined saturation of a second color, wherein the first predetermined saturation normally is achieved by placing the article in a first liquid colorant for a 100 percent single dip saturation time and then drying the article for a first 100 percent single dip saturation drying time, and the second predetermined saturation normally is achieved by placing the article in a second liquid colorant for a second 100 percent single dip saturation time and drying the article for a second 100 percent single dip saturation drying time, the method comprising the steps of:
(a) placing the article in the first liquid colorant for a first short period, the first short period being less than the 100 percent single dip saturation time;
(b) removing the article from the first liquid colorant for a first drying time period;
(c) placing the article back into the first liquid colorant for a second short period, the second short period being less than the first 100 percent single dip saturation time;
(d) removing the article from the first liquid colorant for a second short drying period;
(e) placing the article in the second liquid colorant for a third short period, the third short period being less than the second 100 percent single dip saturation time;
(f) removing the article from the second liquid colorant for a third short drying period;
(g) placing the article back into the second liquid colorant for a fourth short period, the fourth short period being less than the second 100 percent single dip saturation time;
(h) removing the article from the second liquid colorant for a fourth short drying period;
wherein the first short period plus the first short drying period plus the second short period plus the second short drying period, when added together, are cumulatively less than the first 100 percent single dip saturation time and first 100 percent single dip saturation drying time; and
wherein the third short period plus the third short drying period plus the fourth short period plus the fourth short drying period, when added together, are cumulatively less than the second 100 percent single dip saturation time and second 100 percent single dip saturation drying time.

19. The method of claim 18, wherein the first area is a different size than the second area.

20. The method of claim 18, further comprising dipping the article of step (d) into a wash bath before dipping the article into the second liquid colorant.

21. The method of claim 18, wherein the first short period, the second short period, the third short period, and the fourth short period are independently between about 5 seconds and about 120 seconds.

22. The method of claim 21, wherein the first short period, the second short period, the third short period, and the fourth short period are independently between about 10 seconds and about 60 seconds.

23. The method of claim 22, wherein the first short period and the second short period are independently less than about 3 percent of the first 100 percent single dip saturation time, and the third short period and the fourth short period are independently less than about 3 percent of the second 100 percent single dip saturation time.

24. The method of claim 18, wherein the light diffuser forms part of a heel counter or of a sole plate of an article of footwear.

25. The method of claim 18, wherein the light diffuser the diffuser is embedded or otherwise mounted on or in a sole structure of an article of footwear.

26. A part of an article of footwear having a colored portion and a light diffuser, wherein the colored portion is formed by:
(a) dipping at least a first portion of the article into a first liquid colorant having a first color to a first predetermined depth for a first short period less than the 100 percent single dip saturation time of the color;
(b) removing the article from the liquid colorant; and
(c) drying the article.
